(19) United States
(12) Patent Application Publication
(10) Pub. No.: US 2024/0227239 A9
(43) Pub. Date: Jul. 11, 2024

(54) Retainer for a Rotating Bit

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 17/970,325

(22) Filed: Oct. 20, 2022

(51) Int. Cl. B28D 1/18

(52) U.S. Cl. CPC B28D 1/188

(57) ABSTRACT

A retainer for a rotating bit and/or pick that includes a slot extending from a forward end of the retainer to a distal end of the retainer. The slot includes a gap profile formed by the configuration or design of a first radial end surface of the slot and a second radial end surface of the slot. The retainer includes a dual corner break formed by a first angled surface extending from the distal end of the retainer to the first radial end surface of the slot and a second angled surface extending from the distal end of the retainer to the second radial end surface of the slot. In additional embodiments, the retainer can include any of or any combination of a lead-in chamfer at the distal end of the retainer, a relief notch extending from the distal end of the retainer, and a compression slot extending from the relief notch. The retainer may be used independently with the rotating bit or it may be used in conjunction with nearly butted or solid generally cylindrical hollow spacers and/or washers.

### CROSS-REFERENCE TO RELATED APPLICATION(S)

The contents of Applicant's co-pending U.S. Non-Provisional application Ser. No. 17/877,084, filed Jul. 29, 2022, Applicant's co-pending U.S. Non-Provisional application Ser. No. 17/146,992, filed Jan. 12, 2021, Applicant's U.S. Provisional Application No. 62/898,654, filed Sep. 11, 2019, Applicant's U.S. Provisional Application No. 62/965,237, filed Jan. 24, 2020, Applicant's U.S. Pat. No. 10,107,098, issued Oct. 23, 2018, and Applicant's U.S. Pat. No. 10,612,376, issued Apr. 7, 2020, are incorporated herein by reference in their entireties

### TECHNICAL FIELD

This disclosure relates to a bit and/or pick for road milling, mining, and trenching equipment, and more particularly, to a retainer for a rotating bit.

### BACKGROUND

Road milling, mining, and trenching equipment utilizes bits and/or picks traditionally set in a bit assembly. Bit assemblies can include a bit and/or pick retained within a bore in a base block. Bit assemblies can also include a bit and/or pick retained by a bit holder and the bit holder retained within a bore in a base block. A plurality of the bit assemblies are mounted on the outside of a rotatable drum, typically in a V-shaped or spiral configuration. A plurality of the bit assemblies can also be mounted on an endless chain and plate configurations. The combinations of bit assemblies have been utilized to remove material from the terra firma, such as degrading the surface of the earth, minerals, cement, concrete, macadam or asphalt pavement. Individual bits and/or picks, bit holders, and base blocks may wear down or break over time due to the harsh road degrading environment. Additionally, the forces and vibrations exerted on the bit assemblies may cause the bit and/or pick to wear away the bore in the base block, the bit and/or pick to wear away the bore in the bit holder, or the bit holder to wear away the bore in the base block. For rotating bits, a slotted retainer, sleeve, and washer disposed circumferentially around the bit shank, for example, are used to maintain the bit in the bit holder. Over time, a gap forms between a bottom of the bit body and a forward face of the bit holder and the gap between a distal end of a sleeve and a forward end of a retainer continues to increase, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a slotted retainer with varying features adjacent a distal end of the retainer will not only ease the insertion of the bit into the bit holder, reduce costs, reduce axial movement, the slotted retainer of the present disclosure also forms nearly 100 percent sealed areas between the inner diameter of the retainer and the outer diameter or the shank, between the bottom of the bit and the retainer, and between the retainer and the bore of the bit older, thereby providing nearly 100 percent uninhibited rotation of the bit, increasing the life of the bit tip insert of the bit due to improved rotation, and increasing the overall life span of the bit, bit holder, and base block.

### SUMMARY

This disclosure relates generally to bit and/or pick assemblies for road milling, mining, and trenching equipment. One implementation of the teachings herein is a retainer that includes a generally cylindrical hollow body portion including an axial forward end and an axial distal end; a first slot extending through a sidewall of the body portion from the axial forward end to the axial distal end; a first angled portion extending from the axial distal end to a first radial end surface of the first slot; and a second angled portion extending from the axial distal end to a second radial end surface of the first slot opposite the first radial end surface of the first slot.

In another implementation of the teachings herein is a bit that includes a body portion; a generally cylindrical shank axially depending from a bottom of the body portion; and a retainer disposed circumferentially about the shank, the retainer including: a generally cylindrical hollow retainer body portion including an axial forward end and an axial distal end; a first slot extending through a sidewall of the retainer body portion from the axial forward end to the axial distal end; a first angled portion extending from the axial distal end to a first radial end surface of the first slot; and a second angled portion extending from the axial distal end to a second radial end surface of the first slot opposite the first radial end surface of the first slot.

These and other aspects of the present disclosure are disclosed in the following detailed description of the embodiments, the appended claims and the accompanying figures.

### BRIEF DESCRIPTION OF THE DRAWINGS

The various features, advantages, and other uses of the apparatus will become more apparent by referring to the following detailed description and drawings, wherein like reference numerals refer to like parts throughout the several views. It is emphasized that, according to common practice, the various features of the drawings are not to-scale. On the contrary, the dimensions of the various features are arbitrarily expanded or reduced for clarity.

FIG. 1 is a perspective view of a prior art standard retainer;

FIG. 2 is a top elevation view of the prior art standard retainer;

FIG. 3 is a perspective view of the prior art standard retainer;

FIG. 4 is a left side elevation view of the prior art standard retainer;

FIG. 5 is a distal end elevation view of the prior art standard retainer;

FIG. 6 is a right side elevation view of the prior art standard retainer;

FIG. 7 is a perspective view of the prior art standard retainer;

FIG. 8 bottom elevation view of the prior art standard retainer;

FIG. 9 is a perspective view of the prior art standard retainer;

FIG. 10 is a distal end elevation view of a prior art bit and bit holder assembly;

FIG. 11 is a cross-sectional view of the prior art bit and bit holder assembly taken along Line A-A of FIG. 10;

FIG. 12 is a detail cross-sectional view of Detail B of the prior art bit and bit holder assembly of FIG. 11;

FIG. 13 is a side elevation view of a prior art bit;

FIG. 14 is a distal end elevation view of the prior art bit and bit holder assembly shown after some use;

FIG. 15 is a cross-sectional view of the prior art bit and bit holder assembly, shown after some use, taken along Line C-C of FIG. 14;

FIG. 16 is a detail cross-sectional view of Detail D of the prior art bit and bit holder assembly, shown after some use, of FIG. 15;

FIG. 17 is a side elevation view of the prior art bit shown after some use;

FIG. 18 is a distal end elevation view of the prior art bit and bit holder assembly shown after further use;

FIG. 19 is a cross-sectional view of the prior art bit and bit holder assemble, shown after further use, taken along Line E-E of FIG. 18;

FIG. 20 is a detail cross-sectional view of Detail F of the prior art bit and bit holder assembly7, shown after further use, of FIG. 19;

FIG. 21 is a side elevation view of the prior art bit and bit holder assembly show after further use;

FIG. 22 is a perspective view of a first illustrated embodiment of a retainer, showing a dual corner break at a distal end of the retainer and a slot including a linear gap profile, in accordance with implementations of this disclosure;

FIG. 23 is a top elevation view of the first illustrated embodiment of the retainer, showing the dual corner break at the distal end of the retainer, in accordance with implementations of this disclosure;

FIG. 24 is a perspective view of the first illustrated embodiment of the retainer, showing the dual corner break at the distal end of the retainer, in accordance with implementations of this disclosure;

FIG. 25 is a left side elevation view of the first illustrated embodiment of the retainer, showing the dual corner break at the distal end of the retainer, in accordance with implementations of this disclosure;

FIG. 26 is a distal end elevation view of the first illustrated embodiment of the retainer, showing the dual corner break at the distal end of the retainer, in accordance with implementations of this disclosure;

FIG. 27 is a right side elevation view of the first illustrated embodiment of the retainer, showing the dual corner break at the distal end of the retainer, in accordance with implementations of this disclosure;

FIG. 28 is a perspective view of the first illustrated embodiment of the retainer, showing the dual corner break at the distal end of the retainer, in accordance with implementations of this disclosure;

FIG. 29 is a bottom elevation view of the first illustrated embodiment of the retainer in accordance with implementations of this disclosure;

FIG. 30 is a perspective view of the first illustrated embodiment of the retainer, showing the dual corner break at the distal end of the retainer, in accordance with implementations of this disclosure;

FIG. 31 is a perspective view of a second illustrated embodiment of a retainer, showing a dual corner break and a lead in chamfer at a distal end of the retainer and a slot including a linear gap profile, in accordance with implementations of this disclosure;

FIG. 32 is a top elevation view of the second illustrated embodiment of the retainer, showing the dual corner break and the lead in chamfer at the distal end of the retainer, in accordance with implementations of this disclosure;

FIG. 33 is a perspective view of the second illustrated embodiment of the retainer, showing the dual corner break and the lead in chamfer at the distal end of the retainer, in accordance with implementations of this disclosure;

FIG. 34 is a left side elevation view of the second illustrated embodiment of the retainer, showing the dual corner break and the lead in chamfer at the distal end of the retainer, in accordance with implementations of this disclosure;

FIG. 35 is a distal end elevation view of the second illustrated embodiment of the retainer, showing the dual corner break and the lead in chamfer at the distal end of the retainer, in accordance with implementations of this disclosure;

FIG. 36 is a right side elevation view of the second illustrated embodiment of the retainer, showing the dual corner break and the lead in chamfer at the distal end of the retainer, in accordance with implementations of this disclosure;

FIG. 37 is a perspective view of the second illustrated embodiment of the retainer, showing the dual corner break and the lead in chamfer at the distal end of the retainer, in accordance with implementations of this disclosure;

FIG. 38 is a bottom elevation view of the second illustrated embodiment of the retainer, showing the lead in chamfer at the distal end of the retainer, in accordance with implementations of this disclosure;

FIG. 39 is a perspective view of the second illustrated embodiment of the retainer, showing the dual corner break and the lead in chamfer at the distal end of the retainer, in accordance with implementations of this disclosure

FIG. 40 is perspective view of a third illustrated embodiment of a retainer, showing a dual corner break, a lead in chamfer, a relief notch, and a compression slot at a distal end of the retainer and a slot including a linear gap profile, in accordance with implementations of this disclosure;

FIG. 41 is a top elevation view of the third illustrated embodiment of the retainer, showing the dual corner break, the lead in chamfer, the relief notch, and the compression slot at the distal end of the retainer, in accordance with implementations of this disclosure;

FIG. 42 is perspective view of the third illustrated embodiment of the retainer, showing the dual corner break, the lead in chamfer, the relief notch, and the compression slot at the distal end of the retainer, in accordance with implementations of this disclosure;

FIG. 43 is left side elevation view of the third illustrated embodiment of the retainer, showing the dual corner break and the lead in chamfer at the distal end of the retainer, in accordance with implementations of this disclosure;

FIG. 44 is a distal end elevation view of the third illustrated embodiment of the retainer, showing the dual corner break, the lead in chamfer, the relief notch, and the compression slot at the distal end of the retainer, in accordance with implementations of this disclosure;

FIG. 45 is a right side elevation view of the third illustrated embodiment of the retainer, showing the dual corner break and the lead in chamfer at the distal end of the retainer, in accordance with implementations of this disclosure;

FIG. 46 is a perspective view of the third illustrated embodiment of the retainer, showing the dual corner break, the lead in chamfer, the relief notch, and the compression slot at the distal end of the retainer, in accordance with implementations of this disclosure;

FIG. 47 is a bottom elevation view of the third illustrated embodiment of the retainer, showing the lead in chamfer, the relief notch, and the compression slot at the distal end of the retainer, in accordance with implementations of this disclosure;

FIG. 48 is a perspective view of the third illustrated embodiment of the retainer, showing the dual corner break, the lead in chamfer, the relief notch, and the compression slot at the distal end of the retainer, in accordance with implementations of this disclosure;

FIG. 49 is a perspective view of a fourth illustrated embodiment of a retainer, showing a dual corner break, a lead in chamfer, a relief notch, and a compression slot at a distal end of the retainer and a slot including a linear gap profile, in accordance with implementations of this disclosure;

FIG. 50 is a top elevation view of the fourth illustrated embodiment of the retainer, showing the dual corner break, the lead in chamfer, the relief notch, and the compression slot at the distal end of the retainer, in accordance with implementations of this disclosure;

FIG. 51 is a perspective view of the fourth illustrated embodiment of the retainer, showing the dual corner break, the lead in chamfer, the relief notch, and the compression slot at the distal end of the retainer, in accordance with implementations of this disclosure;

FIG. 52 is a left side elevation view of the fourth illustrated embodiment of the retainer, showing the dual corner break and the lead in chamfer at the distal end of the retainer, in accordance with implementations of this disclosure;

FIG. 53 is a distal end elevation view of the fourth illustrated embodiment of the retainer, showing the dual corner break, the lead in chamfer, the relief notch, and the compression slot at the distal end of the retainer, in accordance with implementations of this disclosure;

FIG. 54 is a right side elevation view of the fourth illustrated embodiment of the retainer, showing the dual corner break and the lead in chamfer at the distal end of the retainer, in accordance with implementations of this disclosure;

FIG. 55 is a perspective view of the fourth illustrated embodiment of the retainer, showing the dual corner break, the lead in chamfer, the relief notch, and the compression slot at the distal end of the retainer, in accordance with implementations of this disclosure;

FIG. 56 is a bottom elevation view of the fourth illustrated embodiment of the retainer, showing the lead in chamfer, the relief notch, and the compression slot at the distal end of the retainer, in accordance with implementations of this disclosure;

FIG. 57 is a perspective view of the fourth illustrated embodiment of the retainer, showing the dual corner break, the lead in chamfer, the relief notch, and the compression slot at the distal end of the retainer, in accordance with implementations of this disclosure;

FIG. 58 is a perspective view of a fifth illustrated embodiment of a retainer, showing a dual corner break, a lead in chamfer, and a relief notch at a distal end of the retainer and a slot including a linear gap profile, in accordance with implementations of this disclosure;

FIG. 59 is a top elevation view of the fifth illustrated embodiment of the retainer, showing the dual corner break, the lead in chamfer, and the relief notch at the distal end of the retainer, in accordance with implementations of this disclosure;

FIG. 60 is a perspective view of the fifth illustrated embodiment of the retainer, showing the dual corner break, the lead in chamfer, and the relief notch at the distal end of the retainer, in accordance with implementations of this disclosure;

FIG. 61 is a left side elevation view of the fifth illustrated embodiment of the retainer, showing the dual corner break and the lead in chamfer at the distal end of the retainer, in accordance with implementations of this disclosure;

FIG. 62 is a distal end elevation view of the fifth illustrated embodiment of the retainer, showing the dual corner break, the lead in chamfer, and the relief notch at the distal end of the retainer, in accordance with implementations of this disclosure;

FIG. 63 is a right side elevation view of the fifth illustrated embodiment of the retainer, showing the dual corner break and the lead in chamfer at the distal end of the retainer, in accordance with implementations of this disclosure;

FIG. 64 is a perspective view of the fifth illustrated embodiment of the retainer, showing the dual corner break, the lead in chamfer, and the relief notch at the distal end of the retainer, in accordance with implementations of this disclosure;

FIG. 65 is a bottom elevation view of the fifth illustrated embodiment of the retainer, showing the lead in chamfer and the relief notch at the distal end of the retainer, in accordance with implementations of this disclosure;

FIG. 66 is a perspective view of the fifth illustrated embodiment of the retainer, showing the dual corner break, the lead in chamfer, and the relief notch at the distal end of the retainer, in accordance with implementations of this disclosure;

FIG. 67 is a perspective view of a prior art bit, shown with a prior art serpentine retainer and a washer disposed around a shank of the prior art bit;

FIG. 68 is a top elevation view of a sixth illustrated embodiment of a retainer, showing a dual corner break, a lead in chamfer, and a relief notch at a distal end of the retainer and a slot including a partially linear and partially angular gap profile, in accordance with implementations of this disclosure;

FIG. 69 is a perspective view of a first illustrated embodiment of a nearly butted spacer in accordance with implementations of this disclosure;

FIG. 70 is a top elevation view of the first illustrated embodiment of the nearly butted spacer in accordance with implementations of this disclosure;

FIG. 71 is a side elevation view of the first illustrated embodiment of the nearly butted spacer in accordance with implementations of this disclosure;

FIG. 72 is an exploded side elevation view of a first illustrated embodiment of a bit assembly, including a bit, the first illustrated embodiment of the nearly butted spacer, the fourth illustrated embodiment of the retainer, a bit holder, and a base block, in accordance with implementations of this disclosure;

FIG. 73 is an exploded side elevation view of the first illustrated embodiment of the bit assembly, showing the bit assembled with the first illustrated embodiment of the nearly butted spacer and the fourth illustrated embodiment of the retainer and the bit holder assembled with the base block, in accordance with implementations of this disclosure;

FIG. 74 is a side elevation view of the first illustrated embodiment of the bit assembly, shown fully assembled, in accordance with implementations of this disclosure;

FIG. 75 is a side elevation view of the first illustrated embodiment of the bit assembly, showing invisible internal elements in dotted lines, in accordance with implementations of this disclosure;

FIG. 76 is a detail cross-sectional view of the first illustrated embodiment of the bit assembly taken along Line G-G of FIG. 75 in accordance with implementations of this disclosure;

FIG. 77 is a perspective view of the fourth illustrated embodiment of the retainer in accordance with implementations of this disclosure;

FIG. 78 is a rear elevation view of the first illustrated embodiment of the bit assembly in accordance with implementations of this disclosure;

FIG. 79 is a cross-sectional view of the first illustrated embodiment of the bit assembly taken along Line H-H of FIG. 78 in accordance with implementations of this disclosure;

FIG. 80 is a cross-sectional view of the first illustrated embodiment of the bit assembly taken along Line H-H of FIG. 78 in accordance with implementations of this disclosure;

FIG. 81 is a detail cross-sectional view of Detail I of the first illustrated embodiment of the bit assembly of FIG. 80 in accordance with implementations of this disclosure;

FIG. 82 is a cross-sectional view of the first illustrated embodiment of the bit assembly taken along Line H-H of FIG. 78 in accordance with implementations of this disclosure;

FIG. 83 is a detail cross-sectional view of Detail J of the first illustrated embodiment of the bit assembly of FIG. 82 in accordance with implementations of this disclosure;

FIG. 84 is a rear elevation view of the first illustrated embodiment of the bit holder assembled with the bit, showing the fourth illustrated embodiment of the retainer and the first illustrated embodiment of the nearly butted spacer after some use, in accordance with implementations of this disclosure;

FIG. 85 is a cross-sectional view of the first illustrated embodiment of the bit holder assembled with the bit, shown after some use, taken along Line K-K of FIG. 84 in accordance with implementations of this disclosure;

FIG. 86 is a detail cross-sectional view of Detail L of the first illustrated embodiment of the bit holder assembled with the bit, shown after some use, of FIG. 85 in accordance with implementations of this disclosure;

FIG. 87 is a side elevation view of the first illustrated embodiment of the bit, assembled with the fourth illustrated embodiment of the retainer and the first illustrated embodiment of the nearly butted spacer, shown after some use, in accordance with implementations of this disclosure;

FIG. 88 is a perspective view of the first illustrated embodiment of the nearly butted spacer in accordance with implementations of this disclosure;

FIG. 89 is a top elevation view of the first illustrated embodiment of the nearly butted spacer in accordance with implementations of this disclosure;

FIG. 90 is a side elevation view of the first illustrated embodiment of the nearly butted spacer in accordance with implementations of this disclosure;

FIG. 91 is an exploded side elevation view of a second illustrated embodiment of a bit assembly, including a bit, the first illustrated embodiment of two nearly butted spacers, the fourth illustrated embodiment of the retainer, a bit holder, and a base block, in accordance with implementations of this disclosure;

FIG. 92 is an exploded side elevation view of the second illustrated embodiment of the bit assembly, showing the bit assembled with two first illustrated embodiment nearly butted spacers and the fourth illustrated embodiment of the retainer and the bit holder assembled with the base block, in accordance with implementations of this disclosure;

FIG. 93 is a rear elevation view of the second illustrated embodiment of the bit assembly in accordance with implementations of this disclosure;

FIG. 94 is a cross-sectional view of the second illustrated embodiment of the bit assembly taken along Line M-M of FIG. 93 in accordance with implementations of this disclosure;

FIG. 95 is a cross-sectional view of the second illustrated embodiment of the bit assembly taken along Line M-M of FIG. 93 in accordance with implementations of this disclosure;

FIG. 96 is a detail cross-sectional view of Detail N of the second illustrated embodiment of the bit assembly of FIG. 95 in accordance with implementations of this disclosure;

FIG. 97 is a cross-sectional view of the second illustrated embodiment of the bit assembly taken along Line M-M of FIG. 93 in accordance with implementations of this disclosure;

FIG. 98 is a detail cross-sectional view of Detail O of the second illustrated embodiment of the bit assembly of FIG. 97 in accordance with implementations of this disclosure;

FIG. 99 is a rear elevation view of the second illustrated embodiment of the bit holder assembled with the bit, showing the fourth illustrated embodiment of the retainer and the first illustrated embodiment of the nearly butted spacer after some use, in accordance with implementations of this disclosure;

FIG. 100 is a cross-sectional view of the second illustrated embodiment of the bit holder assembled with the bit, shown after some use, taken along Line P-P of FIG. 99 in accordance with implementations of this disclosure;

FIG. 101 is a detail cross-sectional view of Detail Q of the second illustrated embodiment of the bit holder assembled with the bit, shown after some use, of FIG. 100 in accordance with implementations of this disclosure;

FIG. 102 is a side elevation view of the second illustrated embodiment of the bit, assembled with the fourth illustrated embodiment of the retainer and the first illustrated embodiment of the nearly butted spacer, shown after some use, in accordance with implementations of this disclosure;

FIG. 103 is a perspective view of a second illustrated embodiment of a nearly butted spacer in accordance with implementations of this disclosure;

FIG. 104 is a top elevation view of the second illustrated embodiment of the nearly butted spacer in accordance with implementations of this disclosure;

FIG. 105 is a side elevation view of the second illustrated embodiment of the nearly butted spacer in accordance with implementations of this disclosure;

FIG. 106 is an exploded side elevation view of a third illustrated embodiment of a bit assembly, including a bit, the second illustrated embodiment of a nearly butted spacer, the fourth illustrated embodiment of the retainer, a bit holder, and a base block, in accordance with implementations of this disclosure;

FIG. 107 is an exploded side elevation view of the third illustrated embodiment of the bit assembly, showing the bit assembled with the second illustrated embodiment of the nearly butted spacer and the fourth illustrated embodiment of the retainer and the bit holder assembled with the base block, in accordance with implementations of this disclosure;

FIG. 108 is a rear elevation view of the third illustrated embodiment of the bit assembly in accordance with implementations of this disclosure;

FIG. 109 is a cross-sectional view of the third illustrated embodiment of the bit assembly taken along Line R-R of FIG. 108 in accordance with implementations of this disclosure;

FIG. 110 is a cross-sectional view of the third illustrated embodiment of the bit assembly taken along Line R-R of FIG. 108 in accordance with implementations of this disclosure;

FIG. 111 is a detail cross-sectional view of Detail S of the third illustrated embodiment of the bit holder assembled with the bit of FIG. 110 in accordance with implementations of this disclosure;

FIG. 112 is a cross-sectional view of the third illustrated embodiment of the bit assembly taken along Line R-R of FIG. 108 in accordance with implementations of this disclosure;

FIG. 113 is a detail cross-sectional view of Detail T of the third illustrated embodiment of the bit holder assembled with the bit of FIG. 112 in accordance with implementations of this disclosure;

FIG. 114 is a rear elevation view of the third illustrated embodiment of the bit holder assembled with the bit, showing the fourth illustrated embodiment of the retainer and the second illustrated embodiment of the nearly butted spacer after some use, in accordance with implementations of this disclosure;

FIG. 115 is a cross-sectional view of the third illustrated embodiment of the bit holder assembled with the bit, shown after some use, taken along Line U-U of FIG. 114 in accordance with implementations of this disclosure;

FIG. 116 is a detail cross-sectional view of Detail V of the third illustrated embodiment of the bit holder assembled with the bit, shown after some use, of FIG. 115 in accordance with implementations of this disclosure;

FIG. 117 is a side elevation view of the third illustrated embodiment of the bit, assembled with the fourth illustrated embodiment of the retainer and the second illustrated embodiment of the nearly butted spacer, shown after some use, in accordance with implementations of this disclosure;

FIG. 118 is a perspective view of the second illustrated embodiment of the nearly butted spacer in accordance with implementations of this disclosure;

FIG. 119 is a top elevation view of the second illustrated embodiment of the nearly butted spacer in accordance with implementations of this disclosure;

FIG. 120 is a side elevation view of the second illustrated embodiment of the nearly butted spacer in accordance with implementations of this disclosure;

FIG. 121 is an exploded side elevation view of a fourth illustrated embodiment of a bit assembly, including a bit, the second illustrated embodiment of a nearly butted spacer, the fourth illustrated embodiment of the retainer, a washer, a bit holder, and a base block, in accordance with implementations of this disclosure;

FIG. 122 is an exploded side elevation view of the fourth illustrated embodiment of the bit assembly, showing the bit assembled with the second illustrated embodiment of the nearly butted spacer, the fourth illustrated embodiment of the retainer, and the washer and the bit holder assembled with the base block, in accordance with implementations of this disclosure;

FIG. 123 is a rear elevation view of the fourth illustrated embodiment of the bit assembly in accordance with implementations of this disclosure;

FIG. 124 is a cross-sectional view of the fourth illustrated embodiment of the bit assembly taken along Line W-W of FIG. 123 in accordance with implementations of this disclosure;

FIG. 125 is a side elevation view of a fourth illustrated embodiment of a bit, assembled with the fourth illustrated embodiment of the retainer, in accordance with implementations of this disclosure;

FIG. 126 is a rear elevation view of a fifth illustrated embodiment of a bit assembly, including the fourth illustrated embodiment of the bit, the fourth illustrated embodiment of the retainer, a bit holder, and a base block, in accordance with implementations of this disclosure;

FIG. 127 is a cross-sectional view of the fifth illustrated embodiment of the bit assembly taken along Line X-X of FIG. 126 in accordance with implementations of this disclosure;

FIG. 128 is an exploded side elevation view of a first illustrated embodiment of a bit holder and base block assembly and the first illustrated embodiment of the bit assembled with the first illustrated embodiment of the nearly butted spacer and the fourth illustrated embodiment of the retainer, prior to assembly with a pneumatic hammer, in accordance with implementations of this disclosure;

FIG. 129 is an exploded side elevation view of the first illustrated embodiment of the bit holder and base block assembly and the first illustrated embodiment of the bit, shown at the beginning of the insertion process with the pneumatic hammer, in accordance with implementations of this disclosure;

FIG. 130 is an exploded side elevation view of the first illustrated embodiment of the bit holder and base block assembly and the first illustrated embodiment of the bit, shown after complete assembly with the pneumatic hammer, in accordance with implementations of this disclosure;

FIG. 131 is an exploded side elevation view of the first illustrated embodiment of the bit holder and base block assembly and the first illustrated embodiment of the bit assembled with the first illustrated embodiment of the nearly butted spacer and the fourth illustrated embodiment of the retainer, prior to assembly with a manual hammer using a cutter bit manual holder, in accordance with implementations of this disclosure;

FIG. 132 is an exploded side elevation view of the first illustrated embodiment of the bit holder and base block assembly and the first illustrated embodiment of the bit, shown at the beginning of the insertion process with the manual hammer using the cutter bit manual holder, in accordance with implementations of this disclosure;

FIG. 133 is an exploded side elevation view of the first illustrated embodiment of the bit holder and base block assembly and the first illustrated embodiment of the bit, shown after complete assembly with the manual hammer using the cutter bit manual holder, in accordance with implementations of this disclosure; and

FIG. 134 is cross-sectional view of the second illustrated embodiment of the bit assembly, including the bit, the first illustrated embodiment of two nearly butted spacers, the fourth illustrated embodiment of the retainer, and the bit holder, showing the two nearly butted spacers and the retainer disposed around the shank of the bit, in accordance with implementations of this disclosure.

### DETAILED DESCRIPTION

Road milling, mining, and trenching equipment utilizes bits and/or picks traditionally set in a bit assembly. Bit assemblies can include a bit and/or pick retained within a bore in a base block. For rotating bits, a slotted retainer, sleeve, and washer disposed circumferentially around the bit shank, for example, have typically been used to maintain the bit in the bit holder. Over time, however, a gap forms between a bottom of the bit body and a forward face of the bit holder and the gap between a distal end of a sleeve and a forward end of a retainer continues to increase, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a slotted retainer with varying features adjacent a distal end of the retainer will not only ease the insertion of the bit into the bit holder, reduce costs, reduce axial movement, the slotted retainer of the present disclosure also forms nearly 100 percent sealed areas between the inner diameter of the retainer and the outer diameter or the shank, between the bottom of the bit and the retainer, and between the retainer and the bore of the bit older, thereby providing nearly 100 percent uninhibited rotation of the bit, increasing the life of the bit tip insert of the bit due to improved rotation, and increasing the overall life span of the bit, bit holder, and base block.

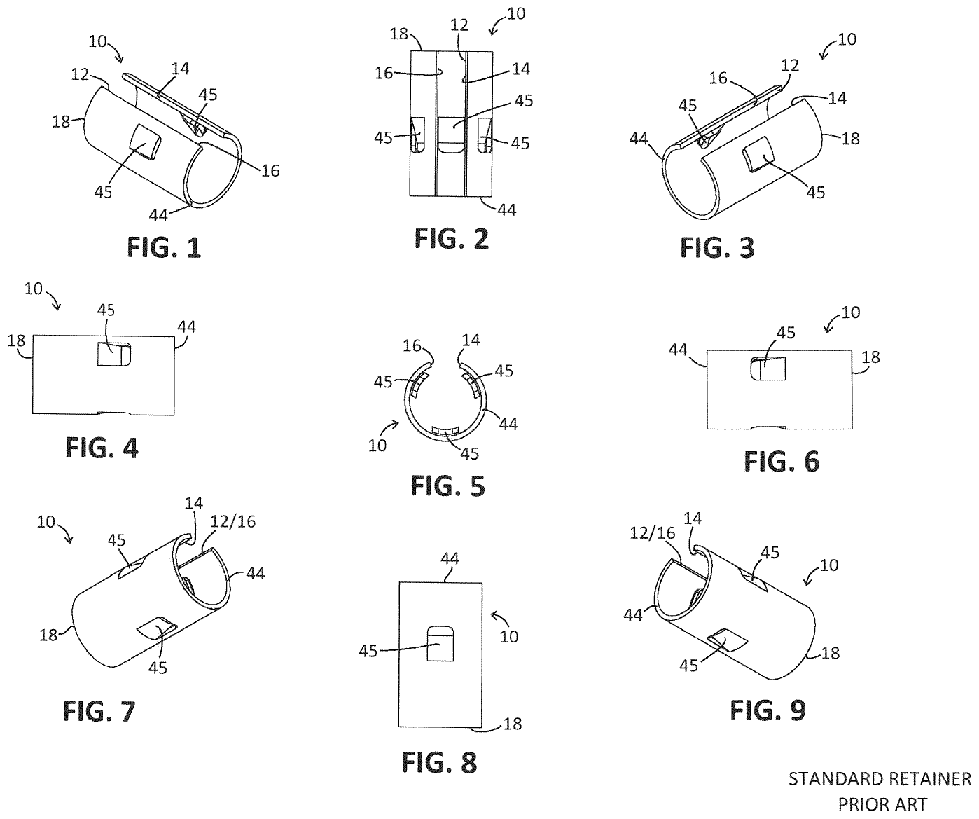

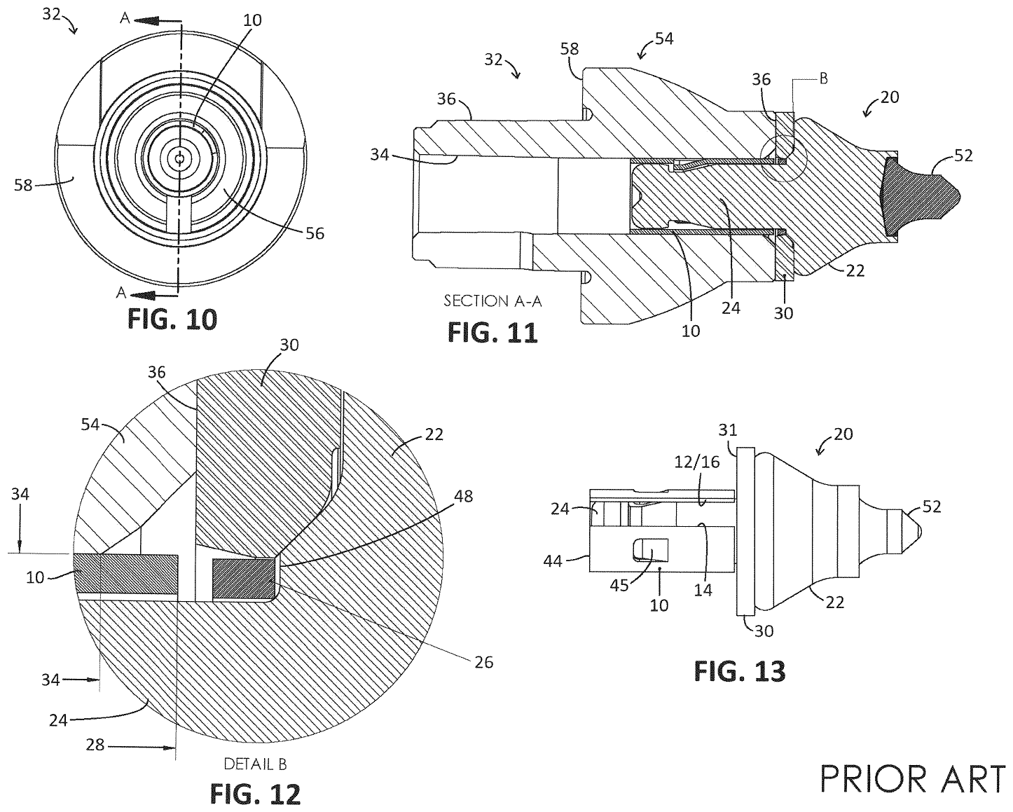

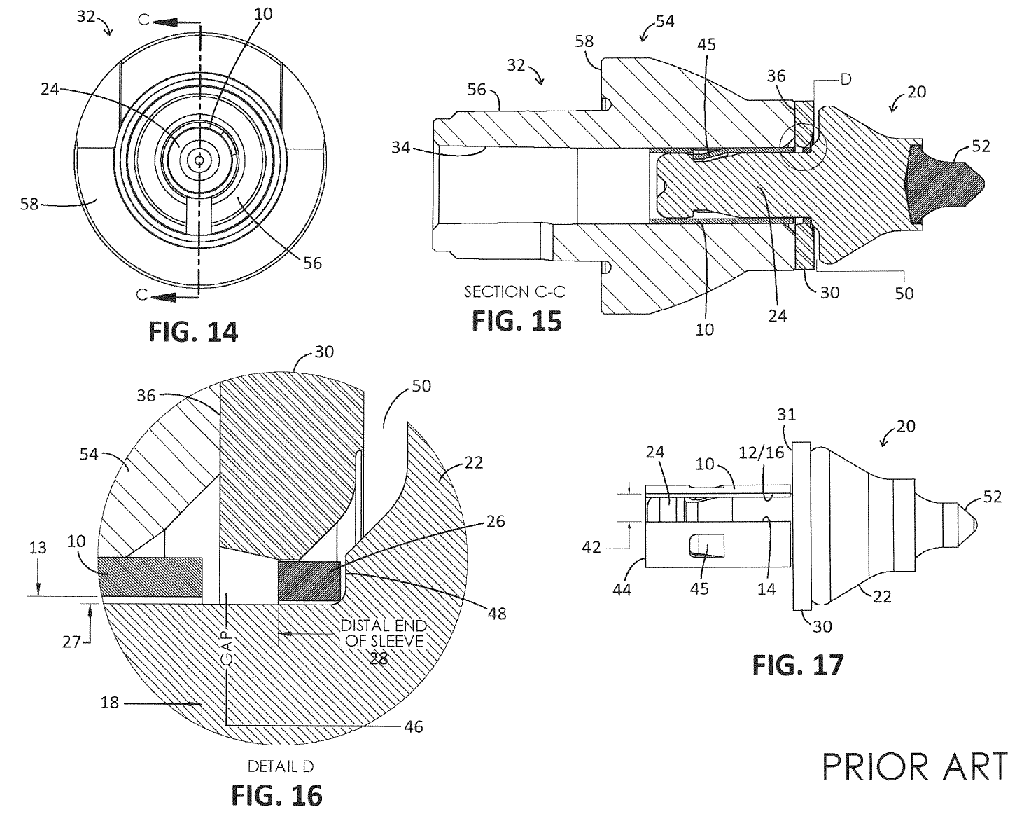

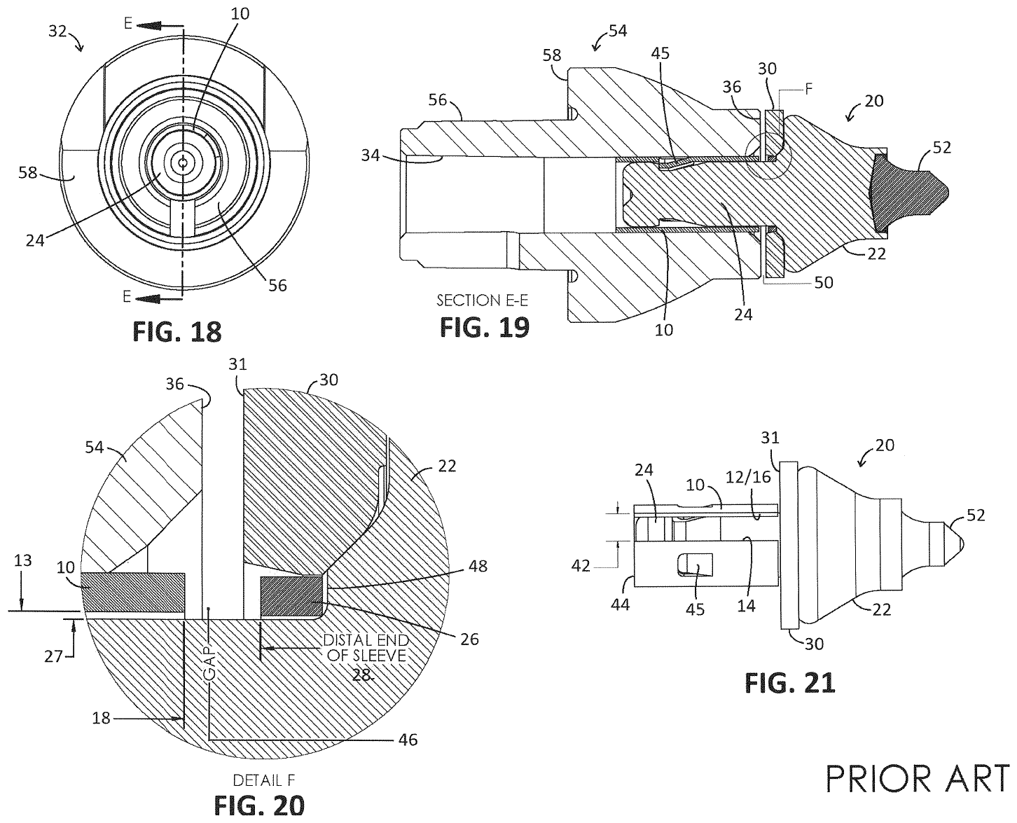

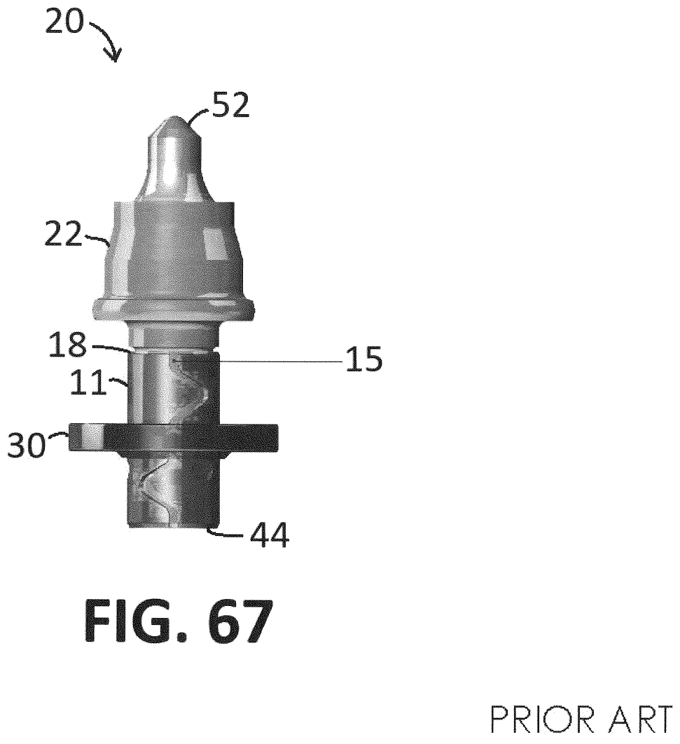

Referring to FIGS. 1-21 and FIG. 67, a prior art retainer 10 and a prior art retainer 11 include a slot 12 and a serpentine slot 15, respectively, extending from a forward end 18 of the retainer 10 to a distal end 44 of the retainer 10, is disposed around a shank 24 of a bit 20. A washer-locating sleeve 26 is mounted onto the shank 24 of the bit 20 prior to the retainer 10 being mounted onto the shank 24 of the bit 20. The sleeve 26 allows a washer 30 to be radially located on the shank 24 of the bit 20. Once the retainer 10 is mounted, the washer 30 is pre-assembled onto the retainer 10 to pre-compress the retainer 10 and allow for easier insertion of the bit shank 24 into a bore 34 of a bit holder 32 that is mounted into a bore 40 of a base block 38, as shown in FIGS. 10-21. A larger gap 42 (FIG. 21) is created between radial end surfaces 14, 16 of the slot 12 of the retainer 10 after insertion of the cutter bit 20 into the bore 34 of the bit holder 32. As the bit assembly, comprising the bit 20, is put to use, the bit body 22 moves away from its seated position against the face 36 of the bit holder 32, shown in FIGS. 15 and 16, due to the centrifugal radial force of a rotating drum when the bit 20 is not engaged in a cutting mode. A gap 46 (FIG. 16) also forms between a distal end 28 of the sleeve 26 and a forward end 18 of the retainer 10, allowing cutting fines to enter the space between the outer diameter 27 of the shank 24 and the inner diameter 13 of the retainer 10, which is required due to the accumulative manufacturing tolerances of the bit body 22, bit shank 24, the retainer 10, and the washer 30. The bit body 22/shank 24, the retainer 10, and the washer 10 are not machined parts. The three part manufacturing dimensional variables are nearly impossible to control and ensure a narrow gap space. Over time, a gap 50 (FIG. 16) between a rear annular flange 48 of the bit body 22 and the face 36 of the bit holder 32 and the gap 46 between the distal end 28 of the sleeve 26 and the forward end 18 of the retainer 10 continues to increase, which results in poorer rotation of the bit 20, reducing the life of a carbide tip 52 of the bit 20 and increasing the bit holder bore 34 wear, as shown in FIGS. 19 and 20.

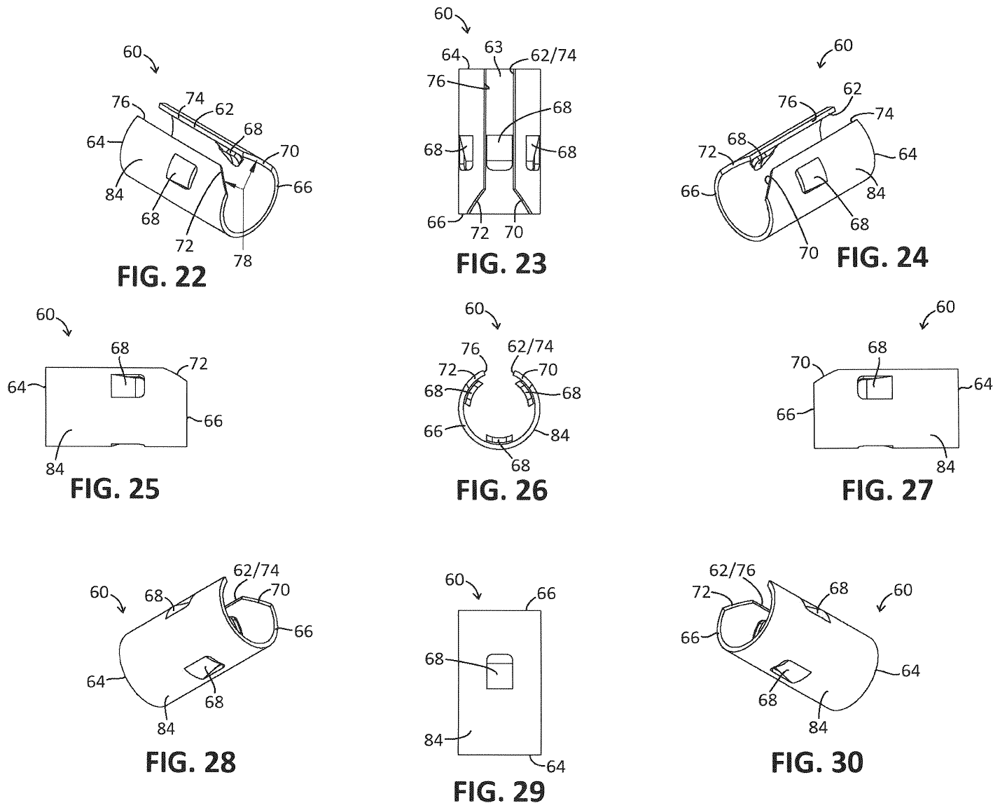

Referring to FIGS. 22-30, a first illustrated embodiment of a retainer 60 is shown in accordance with implementations of this disclosure. Retainer 60 includes a slot 62 axially extending from a forward end 64 of the retainer 60 to a distal end 66 of the retainer. The slot 62 comprises a gap profile 63 (FIG. 23) that is defined by a first radial end surface 74 of the slot 62 and a second radial end surface 76 of the slot 62. In this exemplary illustrated implementation, the radial end surfaces 74, 76 are linear throughout their axial length thereby defining a linear gap profile 63. In alternate embodiments of the retainers described herein, the radial end surfaces 74, 76 and the gap profile 63 and/or gap profile 232, described below, may be parallel, serpentine, arcuate, angular, zig-zagged, or any other configuration that can be formed by the radial end surfaces 74, 76 of the slot 62 or combination of same. The retainer 60 comprises a first angled portion 70 that extends from the distal end 66 of the retainer 60 to the first radial end surface 74 of the slot 62 and a second angled portion 72 that extends from the distal end 66 of the retainer 60 to the second radial end surface 76 of the slot 62. A dual corner break 78 (FIG. 22) is formed by the first angled portion 70 and the second angled portion 72, which allows for good and/or easier insertion of the distal end 66 of the retainer 60, disposed circumferentially about the shank 24 of the bit 20, into the bore 34 of the bit holder 32. The bit 20 comprising an enlarged tire portion 23 that includes a diameter that is generally the same as a diameter of a nose portion 55 of the bit holder 32.

The retainer 60 also comprises at least one axially and radially inwardly extending axial locator tab 68 that is a predetermined distance from the distal end 66 of the retainer 60. The at least one tab 68 is radially inwardly positioned on a portion of the retainer 60 and forms a tab aperture 104 on the wall of the retainer 60 that terminates at a distal end 106 of the tab aperture 104. The at least one tab 68 is adapted to engage a recess or flange 29 (FIGS. 72, 79, 81, 85, 91, 94, 96, 100, 106, 109, 111, 115, 121, 124, 125, and 127) adjacent a distal end of the bit shank 24 to prevent the retainer 60 from being removed from the shank 24 when the bit 20 is extracted from the bore 34 of the bit holder 32. In the exemplary illustrated embodiments described herein, the retainer includes three axially and radially inwardly extending tabs 68. In other embodiments, the retainer can include any number of axially and radially inwardly extending tabs. In yet another embodiment, the retainer 60 can comprise at least one aperture (not shown) that is a predetermined distance from the distal end 66 of the retainer 60. In yet other embodiments, the retainers described herein can simply comprise a generally cylindrical collapsible body portion and a slot that axially extends along the length of the retainer 60 and creates a narrow gap between opposing sidewalls or radial end surfaces of the slot, the slot comprising a gap profile defined by the opposing sidewalls with various possible configurations and/or combinations as described above.

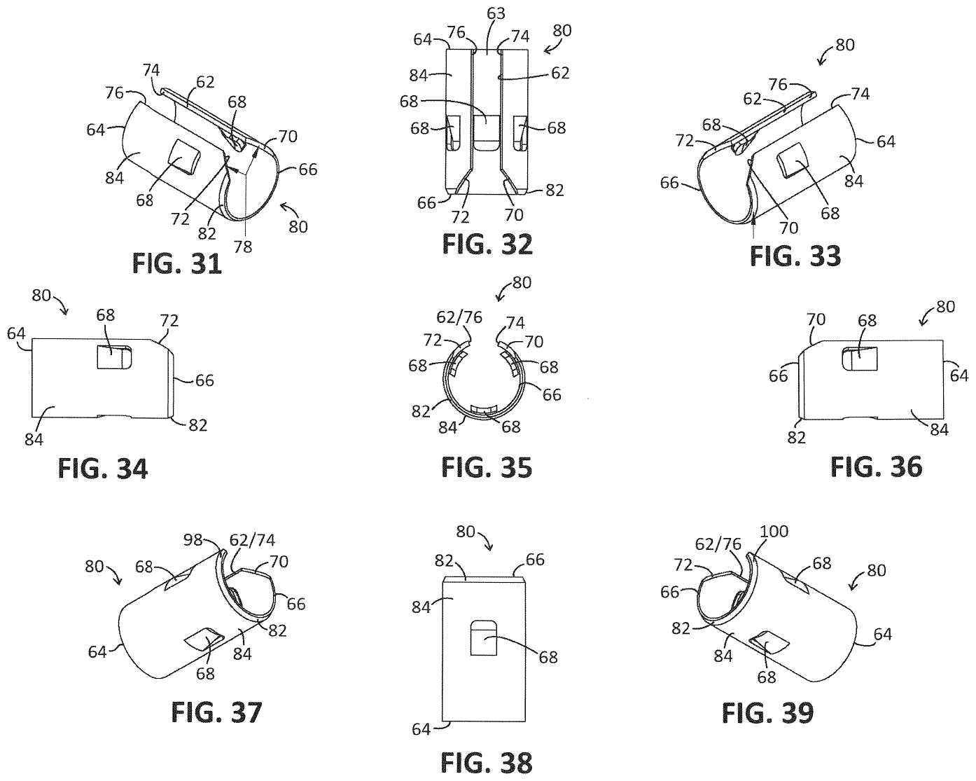

Referring to FIGS. 31-39, a second illustrated embodiment of a retainer 80 is substantially the same as the retainer 60 of the first illustrated embodiment with an exception that the retainer 80 includes a lead-in chamfer 82 that extends from the distal end 66 of the retainer 80 to an outer surface 84 of the retainer 80. The lead-in chamfer 82 allows about 50% less distal end 66 contact at a first contact surface 98 (FIG. 37) and a second contact surface 100 (FIG. 39) on the retainer 110 with the inner wall of the bore 34 of the bit holder 32, which is beneficial during the initial insertion of the retainer 110 into the bore 34 of the bit holder 32. The addition of the dual corner break 78 (FIG. 31) combined with the lead-in chamfer 82 allows for better insertion of the distal end 66 of the retainer 80 into the bore 34 of the bit holder 32.

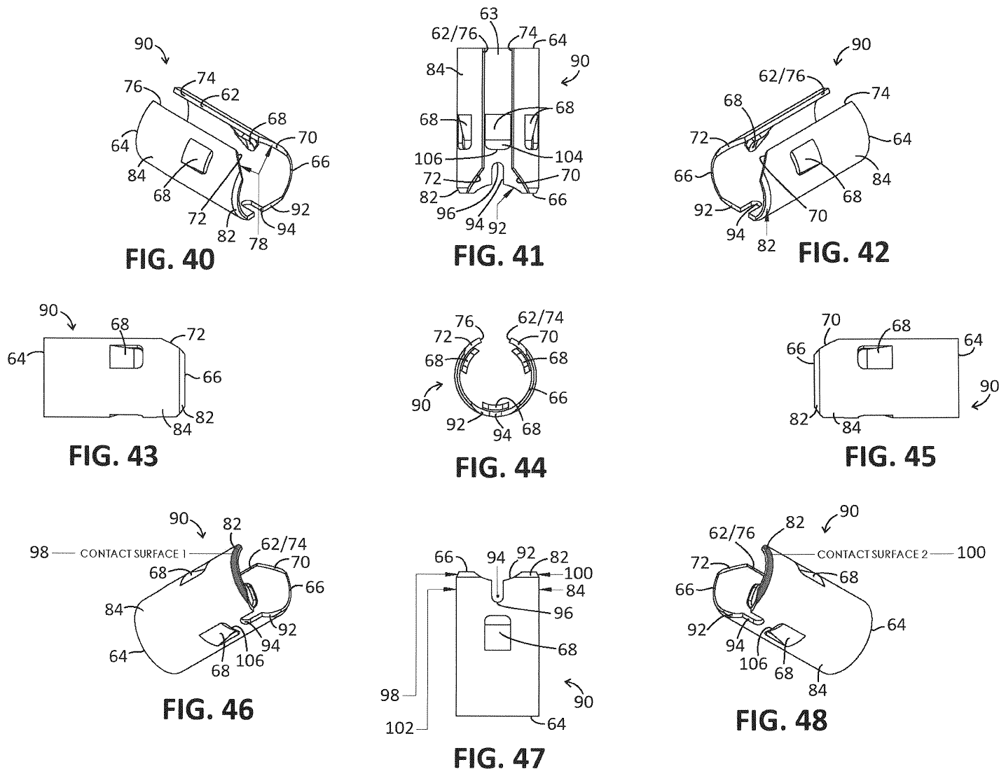

Referring to FIGS. 40-48, a third illustrated embodiment of a retainer 90 is substantially the same as the first illustrated embodiment of the retainer 60 and the second illustrated embodiment of the retainer 80 with an exception that the retainer 90 includes a relief notch 92, which is arcuate in this illustrated exemplary implementation, extending from the distal end 66 of the retainer 90. A compression slot 94 axially extends from a central portion of the relief notch 92 to a slot termination 96 (FIGS. 41 and 47) adjacent to the distal end 106 (FIGS. 41, 46, and 48) of the tab aperture 104 (FIG. 41) formed by one of the axially and radially inwardly extending tabs 68. As with the embodiments of the retainers described herein, the lead-in chamfer 82 allows about 50% less distal end 66 contact at the first contact surface 98 (FIG. 46) and the second contact surface 100 (FIG. 48) on the retainer 90 with an inner wall of the bore 34 of the bit holder 32, which is beneficial during the initial insertion of the retainer 90 into the bore 34 of the bit holder 32. During insertion, the direction of collapse 102 (FIG. 47) is radial, occurring initially adjacent the distal end 66 of the retainer 90. The addition of the relief notch 92 and the compression slot 94, combined with the dual corner break 78 (FIG. 40) and the lead-in chamfer 82, allows for better insertion of the distal end 66 of the retainer 90 into the bore 34 of the bit holder 32.

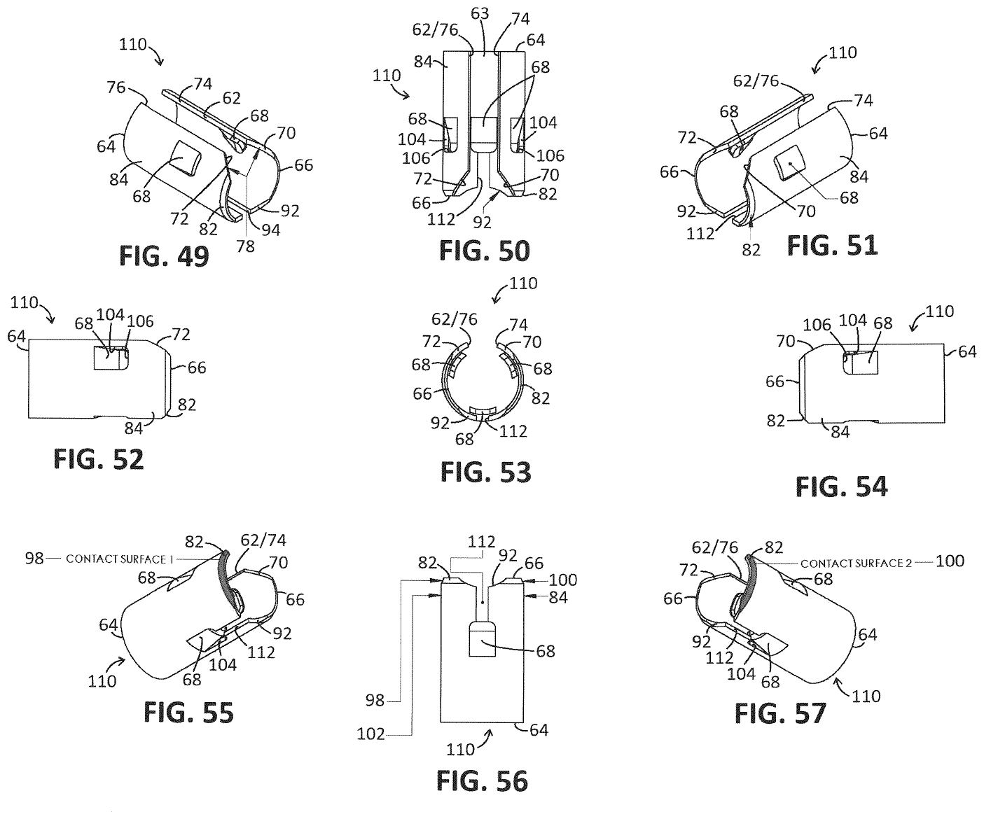

Referring to FIGS. 49-57, a fourth illustrated embodiment of a retainer 110 is substantially the same as the first illustrated embodiment of the retainer 60, the second illustrated embodiment of the retainer 80, and the third illustrated embodiment of the retainer 90 with an exception that the retainer 110 includes a compression slot 112 that axially extends from the central portion of the relief notch 92 to the distal end 106 of the tab aperture 104 created by one of the axially and radially inwardly extending tabs 68. As with the embodiments of the retainers described herein, the lead-in chamfer 82 allows about 50% less distal end 66 contact at the first contact surface 98 (FIG. 55) and the second contact surface 100 (FIG. 57) on the retainer 110 with the inner wall of the bore 34 of the bit holder 32, which is beneficial during the initial insertion of the retainer 110 into the bore 34 of the bit holder 32. During insertion, the direction of collapse 102 (FIG. 56) is radial, occurring initially adjacent the distal end 66 of the retainer 110. The addition of the relief notch 92 and the extended compression slot 112, combined with the dual corner break 78 (FIG. 49) and the lead-in chamfer 82, allows for better insertion of the distal end 66 of the retainer 110 into the bore 34 of the bit holder 32.

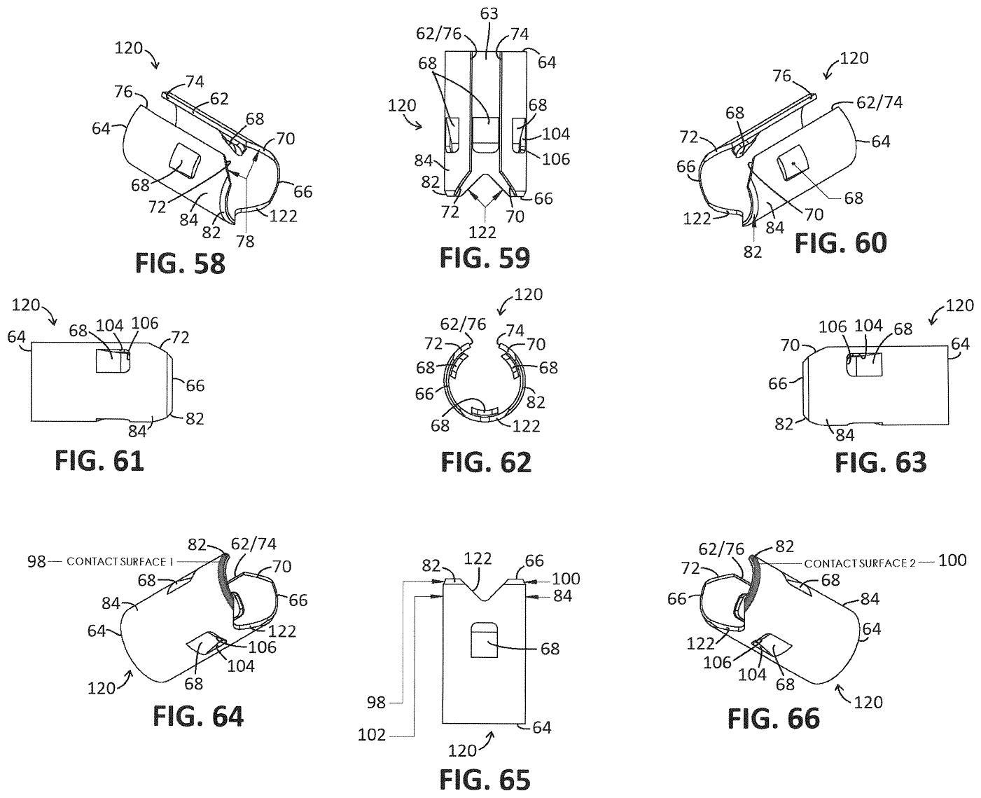

Referring to FIGS. 58-66, a fifth illustrated embodiment of a retainer 120 is substantially the same as first illustrated embodiment of the retainer 60 and the second illustrated embodiment 80 with an exception that the retainer 120 includes a relief notch 122, which is angular in this illustrated exemplary implementation, extending from the distal end 66 of the retainer 120. As with the embodiments of the retainers described herein, the lead-in chamfer 82 allows about 50% less distal end 66 contact at the first contact surface 98 (FIG. 64) and the second contact surface 100 (FIG. 66) on the retainer 120 with the inner wall of the bore 34 of the bit holder 32, which is beneficial during the initial insertion of the retainer 120 into the bore 34 of the bit holder 32. During insertion, the direction of collapse 102 (FIG. 65) is radial, occurring initially adjacent the distal end 66 of the retainer 120. The addition of the relief notch 122, combined with the dual opposite corner break 78 (FIG. 58) and the lead-in chamfer 82, allows for easier insertion of the distal end 66 of the retainer 120 into the bore 34 of the bit holder 32.

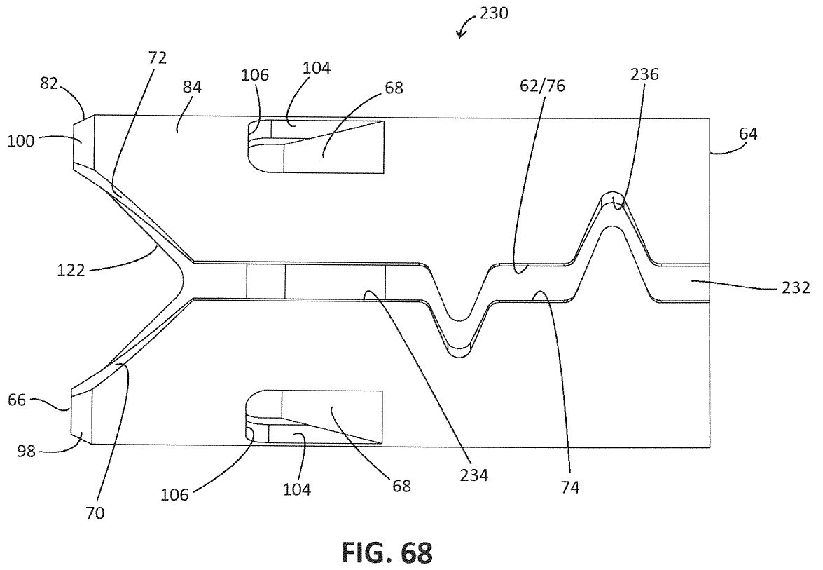

Referring to FIG. 68, a sixth illustrated embodiment of a retainer 230 is substantially the same as fifth illustrated embodiment of the retainer 120 with an exception that the retainer 230 includes the slot 62 comprising a gap profile 232 defined by the first radial end surface 74 of the slot 62 and the second radial end surface 76 of the slot 62. In this exemplary illustrated implementation, the radial end surfaces 74, 76 are partially linear, including at least one linear portion 234, and partially angular and/or serpentine, including at least one serpentine portion 236, thereby defining a partially linear/partially serpentine gap profile 232. In alternate embodiments, the radial end surfaces 74, 76 and the gap profile 230 may be parallel, serpentine, arcuate, angular, zig-zagged, or any other configuration that can be formed by the radial end surfaces 74, 76 of the slot 62 or combination of same. In yet other alternate embodiments, the retainer 230 can simply comprise a generally cylindrical collapsible body portion and a slot that axially extends along the length of the retainer 230 and creates a narrow gap between opposing sidewalls or radial end surfaces of the slot, the slot comprising a gap profile defined by the opposing sidewalls with various possible configurations and/or combinations as described above. In yet other alternate embodiments, the retainer 230 may include any of or any combination of the dual corner break 78, the lead-in chamfer 82, relief notch 92, compression slot 94, compression slot 112, and/or relief notch 122. As with the embodiments of the retainers described herein, the lead-in chamfer 82 allows about 50% less distal end 66 contact at the first contact surface 98 and the second contact surface 100 on the retainer 230 with the inner wall of the bore 34 of the bit holder 32, which is beneficial during the initial insertion of the retainer 230 into the bore 34 of the bit holder 32. During insertion, the direction of collapse 102 is radial, occurring initially adjacent the distal end 66 of the retainer 230. The addition of the relief notch 122, combined with the dual opposite corner break 78 and the lead-in chamfer 82, allows for easier insertion of the distal end 66 of the retainer 120 into the bore 34 of the bit holder 32

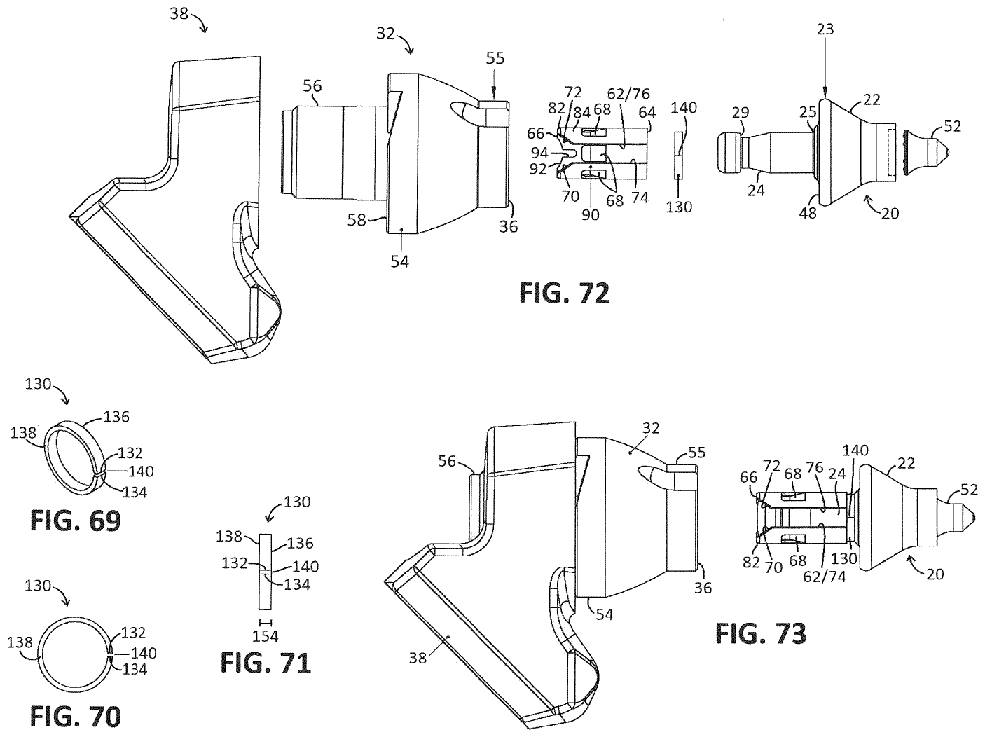

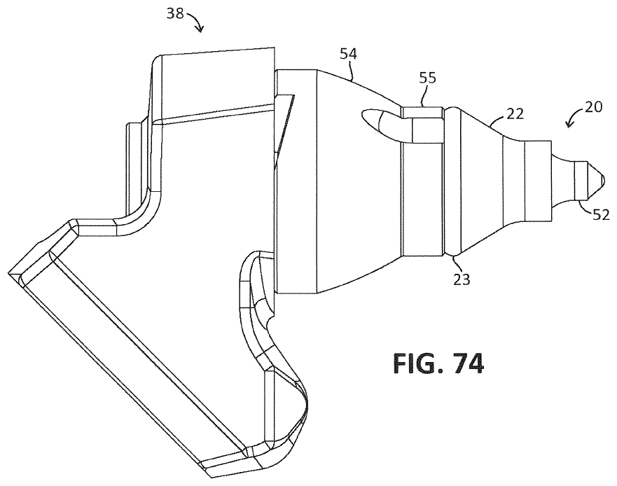

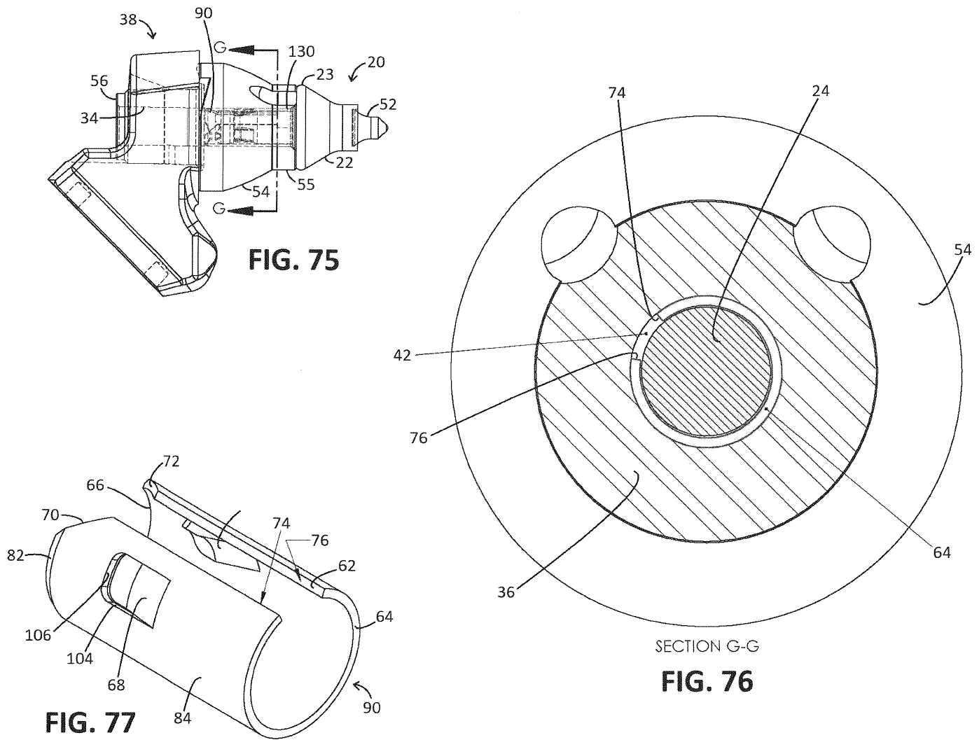

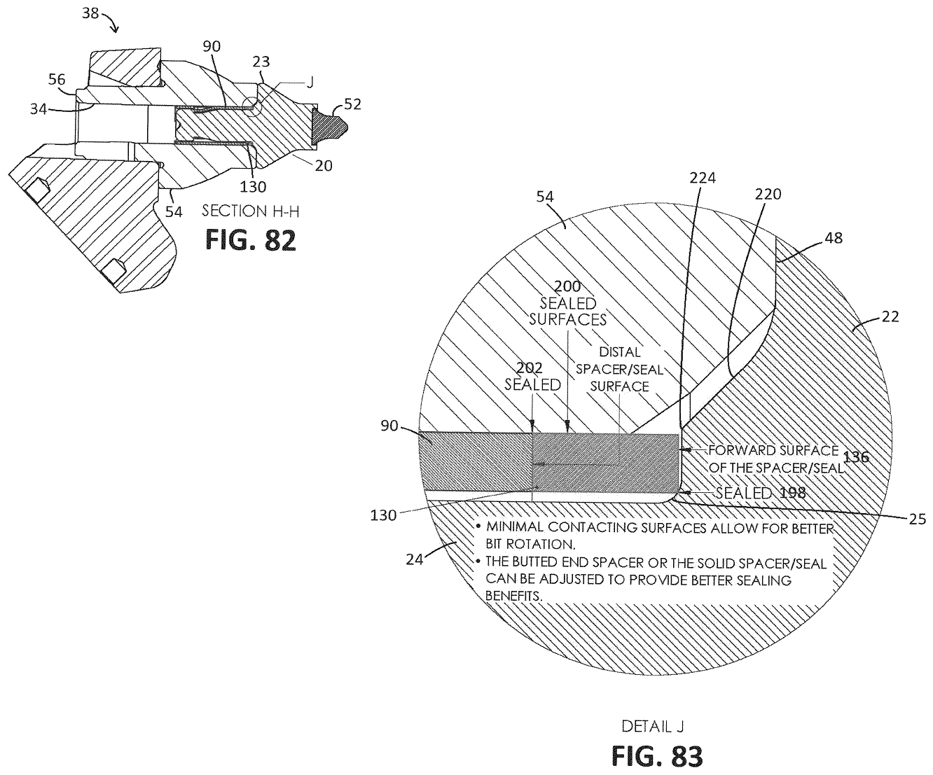

Referring to FIGS. 69-73, 79-83, 85-92, 94-98, and 100-102, a first illustrated embodiment of at least one generally cylindrical hollow spacer 130 includes nearly butted ends 140 comprising a first radial end surface 132 and a second radial end surface 134 opposite the first radial end surface 132. The first radial end surface 132 and the second radial end surface 134 of the spacer 130 are nearly butted 140 in that they are minimally spaced apart from each other, creating a minimal gap between the two, shown in detail in FIGS. 69-71. In alternate embodiments, the at least one spacer 130 may be a solid one piece generally cylindrical hollow spacer excluding the minimal gap. The at least one spacer 130 is disposed circumferentially about the bit shank 24 of the bit 20 such that a forward end 136 of the spacer 130 is adjacent a distal end 224 (FIGS. 81, 83, 86, 96, 98, and 101) of an angled or angular portion 220 (FIGS. 81, 83, 86, 96, 98, and 101), of the bit body 22, the angled portion 220 adjacent the rear annular flange 48 of the bit body 22, and a distal end 138 of the spacer is adjacent the forward end 64 of the retainer 60, 80, 90, 110, 120, 230. The angular portion 220, in this exemplary illustrated implementation, includes a 45 degree angled outer surface that allows the angle at a mouth 35 (FIGS. 86, 101, 113, and 116) of the bore 34, adjacent the forward face 36 of the bit holder 32, to be reproduced and/or regenerated. This refitting wear reproduces the 45 degree angle, in this exemplary illustrated implementation, to reproduce the 45 degree angle at the mouth 35 of the bore 34 of the bit holder 32.

The radial end surfaces 74, 76 of the retainer 60, 80, 90, 110, 120, 230 remain gapped/open 42 (FIG. 76) even after the bit shank 24 is inserted into the bore 34 of the bit holder 32. The distal end 138 of the spacer 130 forming a significant seal with the forward end 64 of the retainer 60, 80, 90, 110, 120, 230, shown in FIGS. 81 and 85, significantly reducing debris from entering the retainer gap 42, nearly eliminating fines from filling the space between the outer diameter 27 of the bit shank 24 and the inner diameter 67 of the retainer 60, 80, 90, 110, 120, 230, and nearly eliminating fines from inhibiting the rotation of the bit 20 in the bore 34 of the bit holder 32, such uninhibited rotation thereby allowing uniform wear at the carbide tip 52 of the bit 20.

The retainer is two to three times more expensive than the sealing spacer, therefore, alternatively, a plurality of spacers 130 may be used to reduce costs. The plurality of spacers 130 are used in much the same way as the single spacer 130 in that the distal end 138 of the spacer 130 closest to the retainer 60, 80, 90, 110, 120, 230, forming a significant seal with the forward end 64 of the retainer 60, 80, 90, 110, 120, 230, shown in FIGS. 96 and 98, significantly reducing debris from entering the retainer gap 42, nearly eliminating fines from filling the space between the outer diameter 27 of the bit shank 24 and the inner diameter 67 of the retainer 60, 80, 90, 110, 120, 230, and nearly eliminating fines from inhibiting the rotation of the bit 20 in the bore 34 of the bit holder 32, such uninhibited rotation thereby allowing uniform wear at the carbide tip of the bit 20. The forward end 136 of the spacer 130, or the forward end 136 of the spacer 130 closest to the rear annular flange 48 of the bit body 22 when a plurality of spacers 130 are used, forms a significant seal with a forward end 25 of the bit shank 24 adjacent the distal end 224 (FIGS. 81, 83, 86, 96, 98, and 101) of the angular portion 220 (FIGS. 81, 83, 86, 96, 98, and 101) of the bit body 22, which further prevents fines from filling the space between the outer diameter 27 of the bit shank 24 and the inner diameter 67 of the retainer 60, 80, 90, 110, 120, 230 as described above.

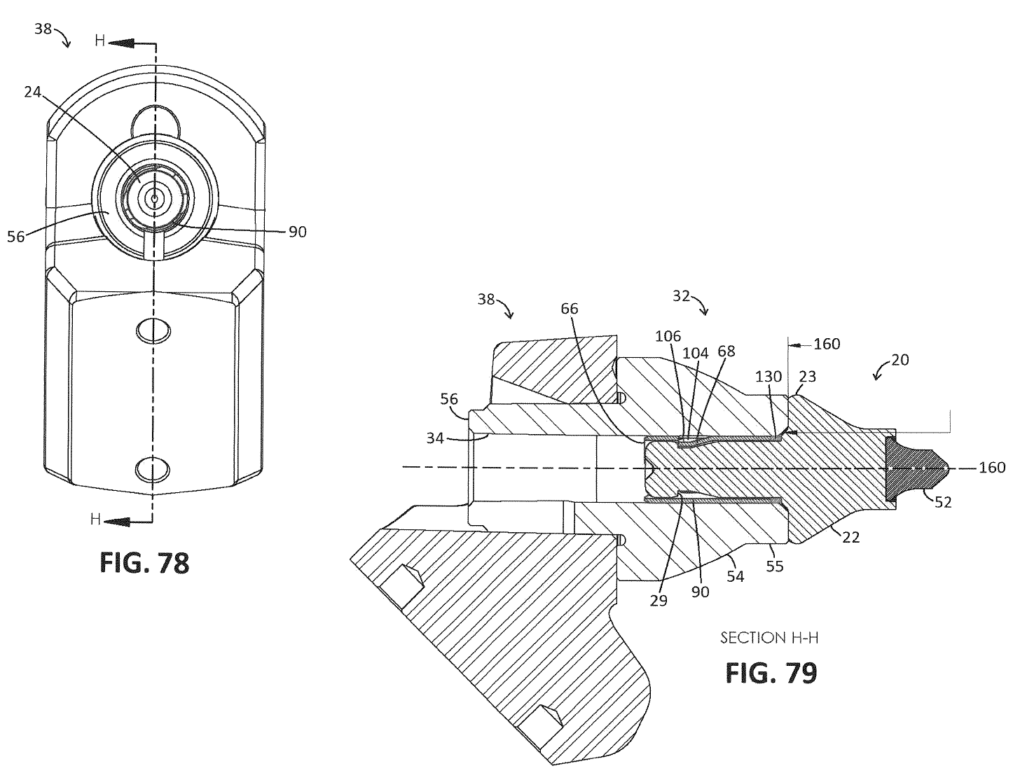

Referring to FIGS. 78 and 79, the forward face 36 of the bit holder 32 comprising the bit 20 will wear perpendicular to its centerline 160 (FIG. 79). The 45 degree angle at the base of the rear annular flange 48 of the cutter bit 20 will continuously regenerate the 45 degree angle 161 at the forward end of the bore 34 of the bit holder 32 after each bit replacement when using the retainer 60, 80, 90, 110, 120, 230 and spacer(s) 130, 150 of the present disclosure. Maintaining this 45 degree angle provides radial and axial support for the cutter bit.

Furthermore, the significant seal formed by the spacer 130, 150 of the present disclosure may index rotationally when the cutter bit rotationally indexes or partially rotates when engaged in the cut during the rotation of the cutter drum. The sealing spacer also provides thrust and radial support when the cutter bit is engaged in the cut. The cutter drum, in this exemplary case, rotates at about 92 revolutions per minute. In this exemplary implementation, the bit will engage the macadam or road surface at 92 impacts per minute and 5,520 impacts per hour. The side surface or the adjacent wall of the trough produced when the bit strikes the macadam or road surface and contacts a side surface of the forward portion of the bit body 22 causes the bit 20 to incrementally index. The continual incremental indexing maintains a nearly frustoconical shape on the tip of the tungsten carbide insert 52 of the bit 20, which increases the useful life of the cutting tool.

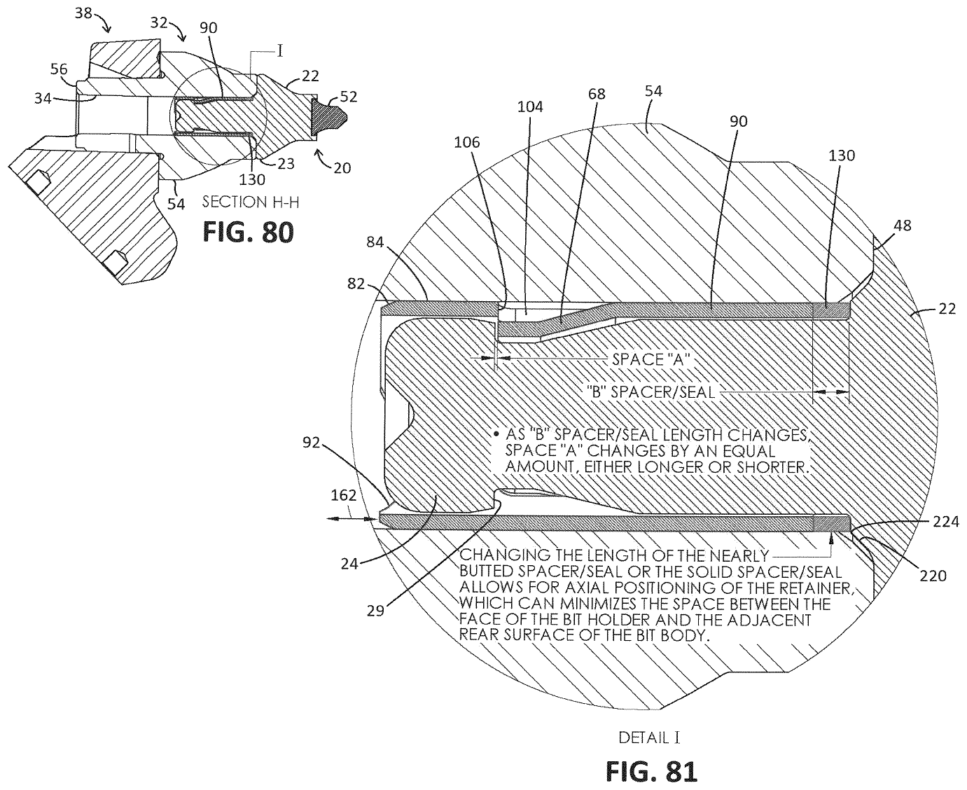

Referring to FIGS. 80 and 81, an axial space “A” is formed between the distal end of the tab 68 and the flange 29 of the bit shank 24. The axial space “A” of the retainer 60, 80, 90, 110, 120, 230 can be achieved by changing the axial length “B” of the spacer/seal 130 162. As the axial length “B” of the spacer/seal 130 changes in length, axial space “A” changes by an equal amount, increasing or decreasing in length. Changing the length of the nearly butted spacer 130 or the solid spacer (not shown) allows for axial positioning of the retainer, which can minimize the space between the face 36 of the bit holder 32 and the adjacent rear surface 48 of the bit body 22 of the bit 20. Due to the accumulative manufacturing tolerances of the retainer dimensions and the accumulative manufactured axial dimensional tolerances of the shank 24 of the bit 20, a variation of a minimum of a 0.030 inch deviation, in this exemplary illustrated implementation, can exist within the same batch of retainer and bit body parts. The spacer/seal length can be manufactured to compensate for these manufacturing deviations. A minimal axial space “A” dimension is ideal to reduce a gap between the forward face 36 of the bit holder 32 and the adjacent rear surface 48 of the bit body 22 of the bit 20 when the cutter bit assembly is positioned in place.

Referring to FIG. 83, the spacer 130 forms a significant seal 198 between the inner forward end 136 of the spacer 130 and the forward end 25 of the bit shank 24 and a portion of the distal end 224 of the angular portion 220 of the bit body 22. The spacer 130 forms a further significant seal 200 between an outer surface of the spacer 130 and an inner surface of the bore 34 of the bit holder 32. Additionally, the spacer 130 forms yet another significant seal 202 between the distal end 138 of the spacer 130 and the forward end 64 of the retainer 60, 80, 90, 110, 120, 230. The split or nearly butted sealing spacer 130 or the solid sealing spacer (not shown) provides significant sealing surfaces to significantly reduce debris from entering the retainer 60, 80, 90, 110, 120, 230 gap 42, nearly eliminating fines from filling the space between an outer diameter 27 of the bit shank 24 and an inner diameter 67 of the retainer 60, 80, 90, 110, 120, 230, and thereby nearly eliminating the fines from inhibiting bit rotation, which bit rotation allows for uniform wear at the carbide tip 52 of the bit 20 since minimal contacting surfaces allow for better bit rotation. The nearly butted spacer 130 and the solid spacer (not shown) can also be adjusted to provide even better sealing benefits.

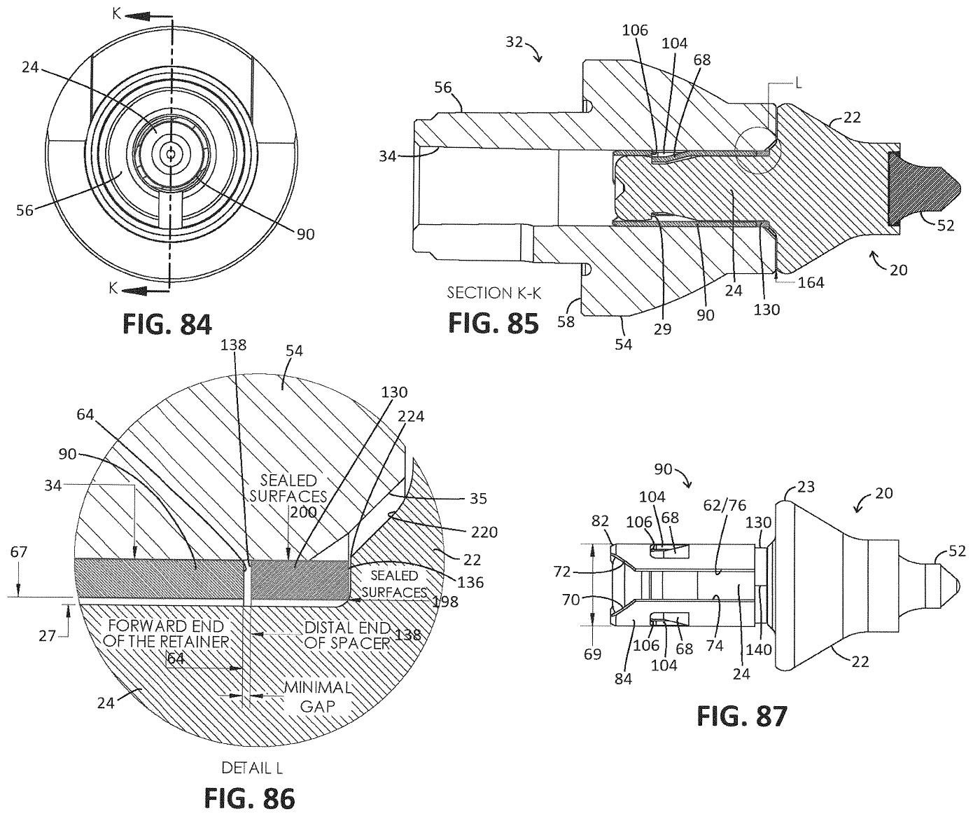

Referring to FIGS. 84-87, the retainer 60, 80, 90, 110, 120, 230 and the spacer(s) 130 do not allow cutting fines to enter the forward space between the outer diameter 27 of the bit shank 24 and the inner diameter 67 of the retainer 60, 80, 90, 110, 120, 230. The designs, implementation, and illustrated embodiments of the present disclosure only allow minimal axial bit body 22 movement away from its seated position, with the rear annular flange 48 seated on the face 36 of the bit holder 32, due to the centrifugal radial force of a rotating drum when the bit is not engaged in a cutting mode 164. The advantages of the present designs include better rotation of the bit 20, increased carbide tip 52 life, and a decrease in bit holder bore 34 wear. The longer the axial length of spacer 130 and spacer 150, the less likely that there would be wear at the mouth 35 (FIGS. 86, 101, 113, and 116) of the bore 34 of the bit holder 32.

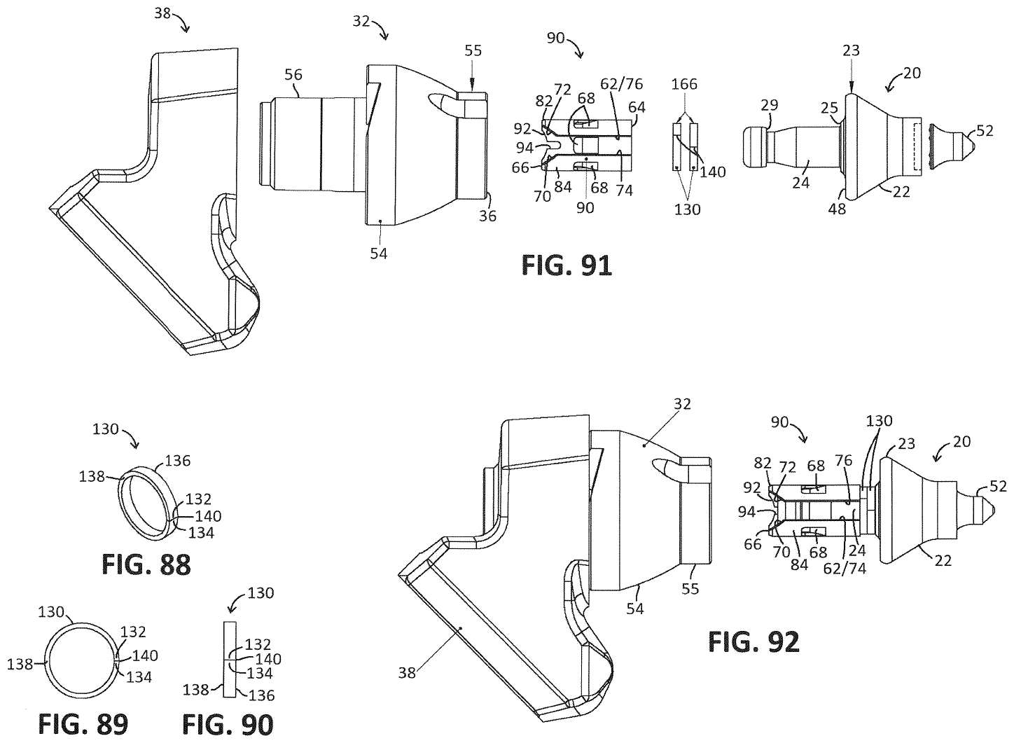

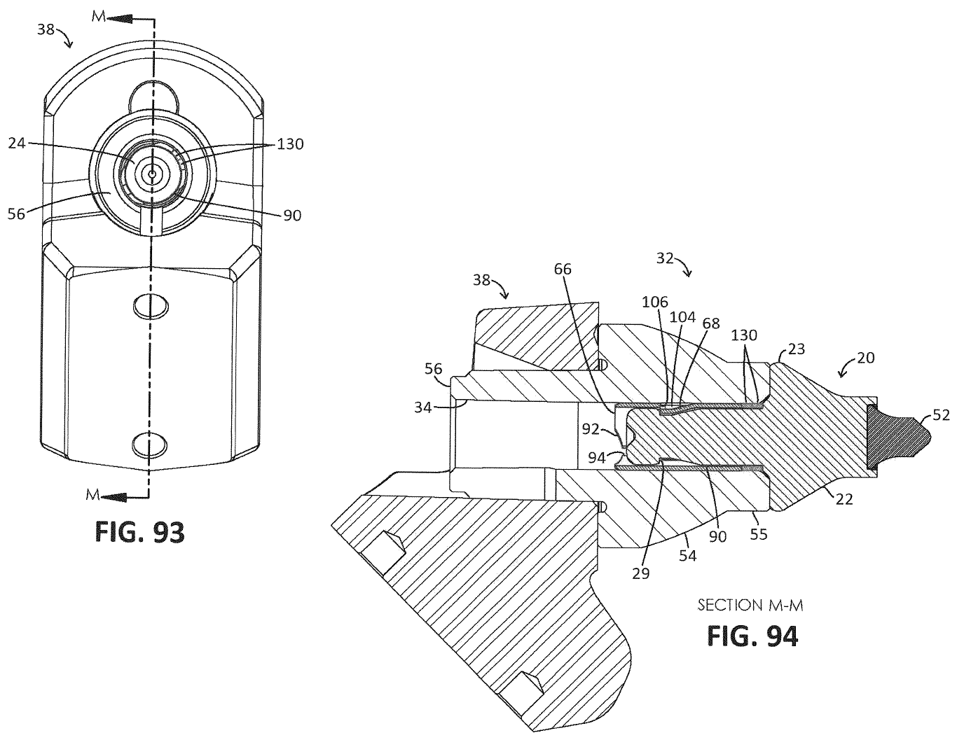

Referring to FIGS. 88-102, a plurality of the first illustrated embodiment of the generally cylindrical hollow spacer 130 may be used. As previously described, the plurality of spacers 130 include nearly butted ends 140 comprising the first radial end surface 132 and the second radial end surface 134 opposite the first radial end surface 132. The first radial end surface 132 and the second radial end surface 134 of the spacer 130 are nearly butted 140 in that they are minimally spaced apart from each other, creating a minimal gap between the two, shown in detail in FIGS. 69-71. In alternate embodiments, the plurality of spacers 130 may be solid one piece generally cylindrical hollow spacers excluding the minimal gap. The plurality of spacers 130 are disposed circumferentially about the bit shank 24 of the bit 20 such that a forward end 136 of the first spacer 130 is adjacent the distal end 224 of the angular portion 220 of the bit body 22 and a distal end 138 of the last spacer 130 is adjacent the forward end 64 of the retainer 60, 80, 90, 110, 120, 230, ensuring that the nearly butted ends 140 of each spacer 130 do not align with each other 166.

The plurality of spacers 130 each include a radial and thrust bearing axial length that can be made accurately in various lengths to satisfy each application requirement, allowing the spacers to be application specific. As described above, the longer the axial length of spacer 130 and spacer 150, the less likely that there would be wear at the mouth 35 (FIGS. 86, 101, 113, and 116) of the bore 34 of the bit holder 32. The retainer and spacer designs of the present disclosure allow for greater than 10 percent cost reduction, zero to very minimal axial movement, require fewer parts to assemble, allow nearly 100 percent sealed surfaces when the bit rotates, and provide for a longer bit carbide tip life due to improved bit rotation.

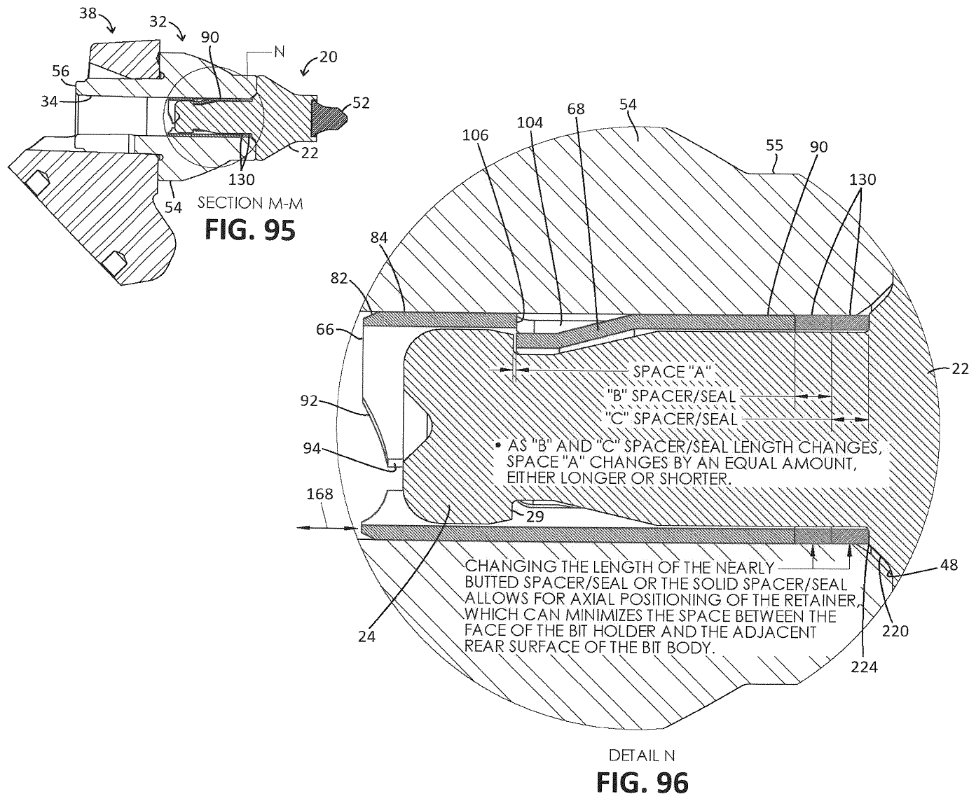

Referring to FIGS. 95 and 96, and as similarly described above with respect to FIG. 81, an axial space “A” is formed between the distal end of the tab 68 and the flange 29 the bit shank 24. The axial space “A” of the retainer 60, 80, 90, 110, 120, 230 can be achieved by changing the axial length “B” and/or “C” of the spacers/seals 130 168. As the axial length “B” and/or “C” of the spacers/seals 130 changes in length, axial space “A” changes by an equal amount, increasing or decreasing in length. Changing the length of the nearly butted spacers 130 or the solid spacers (not shown) allows for axial positioning of the retainer, which can minimize the space between the face 36 of the bit holder 32 and the adjacent rear surface 48 of the bit body 22 of the bit 20.

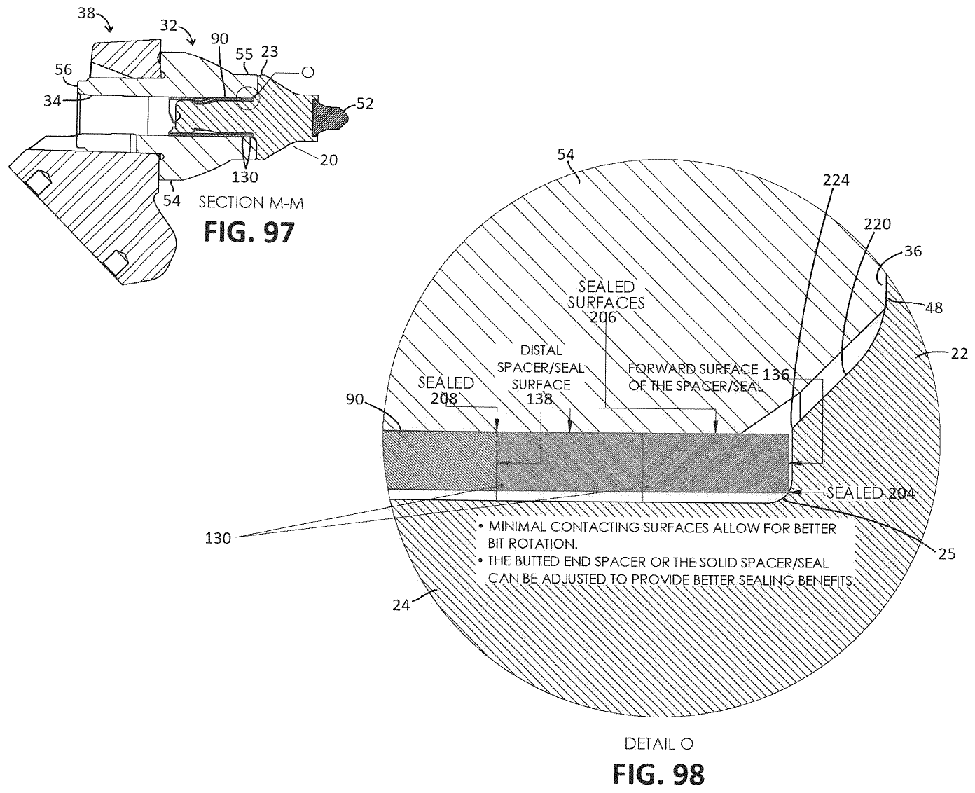

Referring to FIGS. 97 and 98, and as similarly described as above with respect to FIG. 83, the forward spacer 130 forms a significant seal 204 between the inner forward end 136 of the forward spacer 130 and the forward end 25 of the bit shank 24 and a portion of the distal end 224 of the angular portion 220 of the bit body 22. The forward spacer 130 and the distal spacer 130 form a significant seal 206 between the outer surface of each spacer 130 and an inner surface of the bore 34 of the bit holder 32. Additionally, the distal spacer 130 forms another significant seal 208 between the distal end 138 of the distal spacer 130 and the forward end 64 of the retainer 60, 80, 90, 110, 120, 230. The split or nearly butted sealing spacers 130 or the solid sealing spacer(s) (not shown) provide significant sealing surfaces to significantly reduce debris from entering the retainer 60, 80, 90, 110, 120, 230 gap 42, nearly eliminating fines from filling the space between an outer diameter 27 of the bit shank 24 and an inner diameter 67 of the retainer 60, 80, 90, 110, 120, 230, and thereby nearly eliminating the fines from inhibiting bit rotation, which bit rotation allows for uniform wear at the carbide tip 52 of the bit 20 since minimal contacting surfaces allow for better bit rotation. The nearly butted spacers 130 and the solid spacers (not shown) can also be adjusted to provide even better sealing benefits.

Referring to FIGS. 99-102, and as similarly described above with respect to FIGS. 84-87, the retainer 60, 80, 90, 110, 120, 230 and the spacers 130 do not allow cutting fines to enter the forward space between the outer diameter 27 of the bit shank 24 and the inner diameter 67 of the retainer 60, 80, 90, 110, 120, 230. The designs, implementations, and illustrated embodiments of the present disclosure only allow minimal axial bit body 22 movement away from its seated position, with the rear annular flange 48 seated on the face 36 of the bit holder 32, due to the centrifugal radial force of a rotating drum when the bit is not engaged in a cutting mode 170. The advantages of the present designs include better rotation of the bit 20, increased carbide tip 52 life, and a decrease in bit holder bore 34 wear.

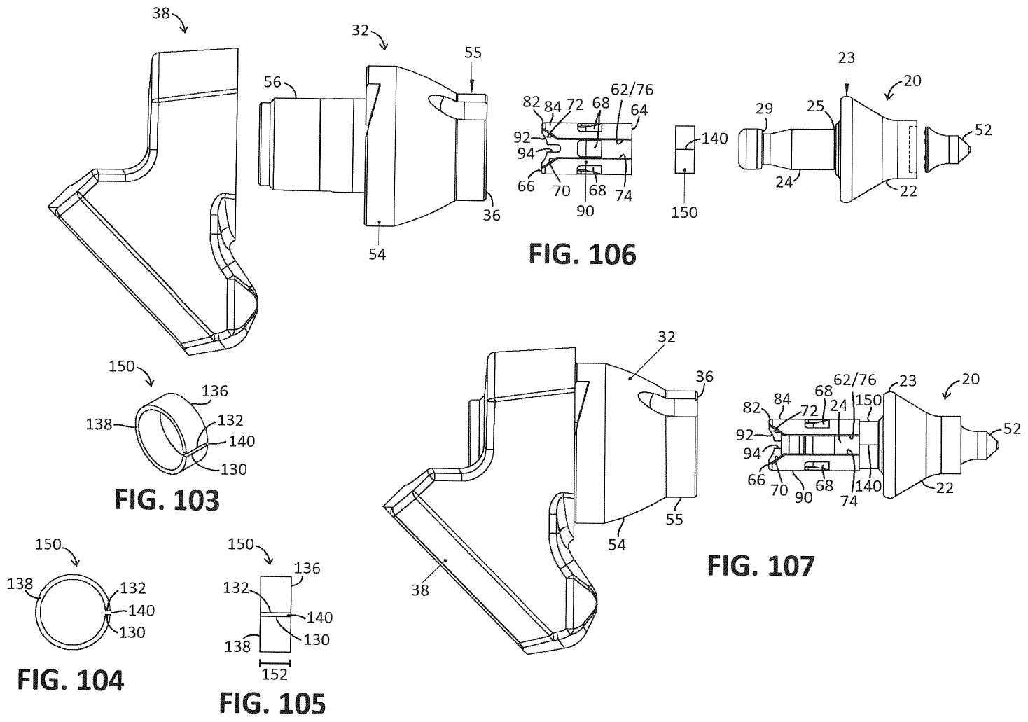

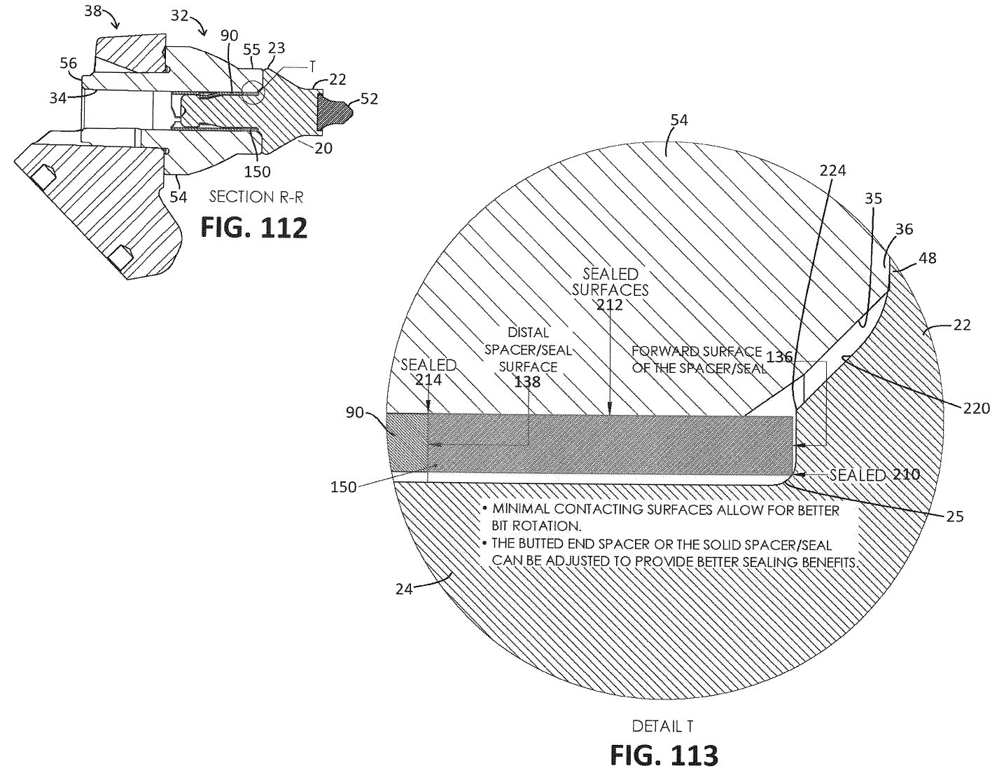

Referring to FIGS. 103-107, 109-113, 115-122, and 124, a second illustrated embodiment of at least one generally cylindrical hollow spacer 150 is substantially the same as the first illustrated embodiment of the spacer 130 with an exception that an axial length 152 (FIG. 105) of the spacer 150 is greater than an axial length 154 (FIG. 71) of the spacer 130, potentially reducing the number of spacers that are needed. As previously described with respect to spacer 130, spacer 150 includes, in this illustrated embodiment, nearly butted ends 140 comprising the first radial end surface 132 and the second radial end surface 134 opposite the first radial end surface 132. The first radial end surface 132 and the second radial end surface 134 of the spacer 130 are nearly butted 140 in that they are minimally spaced apart from each other, creating a minimal gap between the two, shown in detail in FIGS. 103-105. In alternate embodiments, the spacer 150 may be a solid one piece generally cylindrical hollow spacer excluding the minimal gap. Spacer 150 is disposed circumferentially about the bit shank 24 of the bit 20 such that the forward end 136 of the spacer 150 is adjacent the distal end 224 (FIGS. 111, 113, and 116) of the angled portion 220 (FIGS. 111, 113, and 116) of the bit body 22 and the distal end 138 of the spacer 150 is adjacent the forward end 64 of the retainer 60, 80, 90, 110, 120, 230. The angular portion 220, in this exemplary illustrated implementation, includes a 45 degree angled outer surface that allows the angle at the mouth 35 (FIGS. 86, 101, 113, and 116) of the bore 34, adjacent the forward face 36 of the bit holder 32, to be reproduced and/or regenerated. This refitting wear reproduces the 45 degree angle, in this exemplary illustrated implementation, to reproduce the 45 degree angle at the mouth 35 of the bore 34 of the bit holder 32.

The spacers 130, 150 include a radial and thrust bearing axial length that can be made accurately in various lengths to satisfy each application requirement, making the spacers application specific. As described above, the longer the axial length of spacer 130 and spacer 150, the less likely that there would be wear at the mouth 35 (FIGS. 86, 101, 113, and 116) of the bore 34 of the bit holder 32. The retainer and spacer design of the present disclosure allows for greater than 10 percent cost reduction, zero to very minimal axial movement, requires fewer parts to assemble, allows nearly 100 percent sealed surfaces when the bit rotates, and provides for a longer bit carbide tip life due to improved bit rotation.

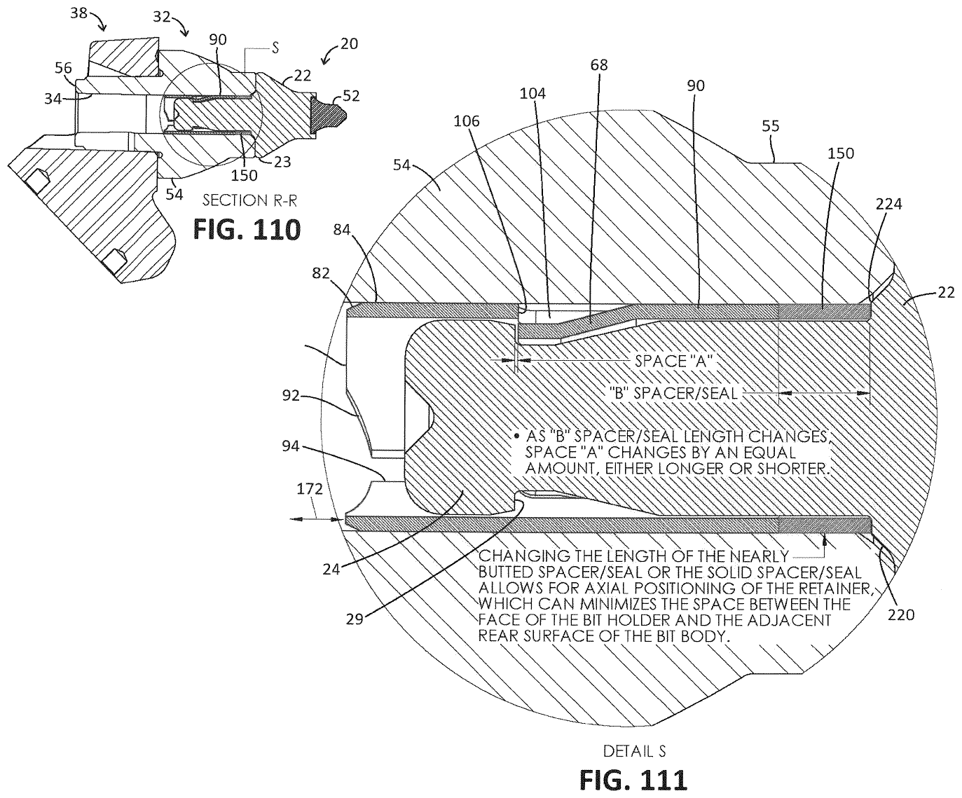

Referring to FIGS. 110 and 111, an axial space “A” is formed between the distal end of the tab 68 and the flange 29 of the bit shank 24. The axial space “A” of the retainer 60, 80, 90, 110, 120, 230 can be achieved by changing the axial length “B” of the spacer/seal 150 172. As the axial length “B” of the spacer/seal 150 changes in length, axial space “A” changes by an equal amount, increasing or decreasing in length. Changing the length of the nearly butted spacer 150 or the solid spacer (not shown) allows for axial positioning of the retainer, which can minimize the space between the face 36 of the bit holder 32 and the adjacent rear surface 48 of the bit body 22 of the bit 20. The longer the axial length of spacer 130 and spacer 150, the less likely that there would be wear at the mouth 35 (FIGS. 86, 101, 113, and 116) of the bore 34 of the bit holder 32.

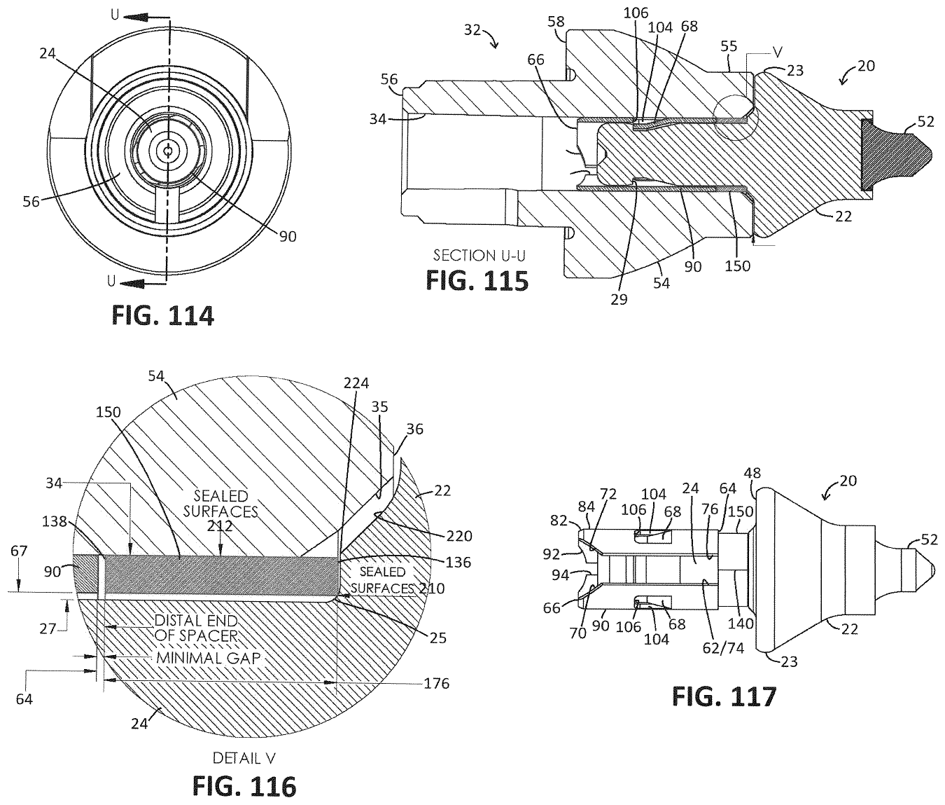

Referring to FIG. 113, the spacer 150 forms a significant seal 210 between the inner forward end 136 of the spacer 150 and the forward end 25 of the bit shank 24 and a portion of the distal end 224 of the angular portion 220 of the bit body 22. The spacer 150 forms a further significant seal 212 between an outer surface of the spacer 150 and an inner surface of the bore 34 of the bit holder 32. Additionally, the spacer 150 forms yet another significant seal 214 between the distal end 138 of the spacer 150 and the forward end 64 of the retainer 60, 80, 90, 110, 120, 230. The split or nearly butted sealing spacer 150 or the solid sealing spacer (not shown) provides significant sealing surfaces to significantly reduce debris from entering the retainer 60, 80, 90, 110, 120, 230 gap 42, nearly eliminating fines from filling the space between an outer diameter 27 of the bit shank 24 and an inner diameter 67 of the retainer 60, 80, 90, 110, 120, 230, and thereby nearly eliminating the fines from inhibiting bit rotation, which bit rotation allows for uniform wear at the carbide tip 52 of the bit 20 since minimal contacting surfaces allow for better bit rotation. The nearly butted spacer 150 and the solid spacer (not shown) can also be adjusted to provide even better sealing benefits.

Referring to FIGS. 114-117, the retainer 60, 80, 90, 110, 120, 230 and the spacer 150 do not allow cutting fines to enter the forward space between the outer diameter 27 of the bit shank 24 and the inner diameter 67 of the retainer 60, 80, 90, 110, 120, 230. The designs, implementations, and illustrated embodiments of the present disclosure only allow minimal axial bit body 22 movement away from its seated position, with the rear annular flange 48 seated on the face 36 of the bit holder 32, due to the centrifugal radial force of a rotating drum when the bit is not engaged in a cutting mode 174 (FIG. 115). A longer engagement 176 (FIG. 116) of the spacer/seal 150 within the bore 34 of the bit holder 32 improves the bit shank 24 support and provides better cutter bit 20 rotation.

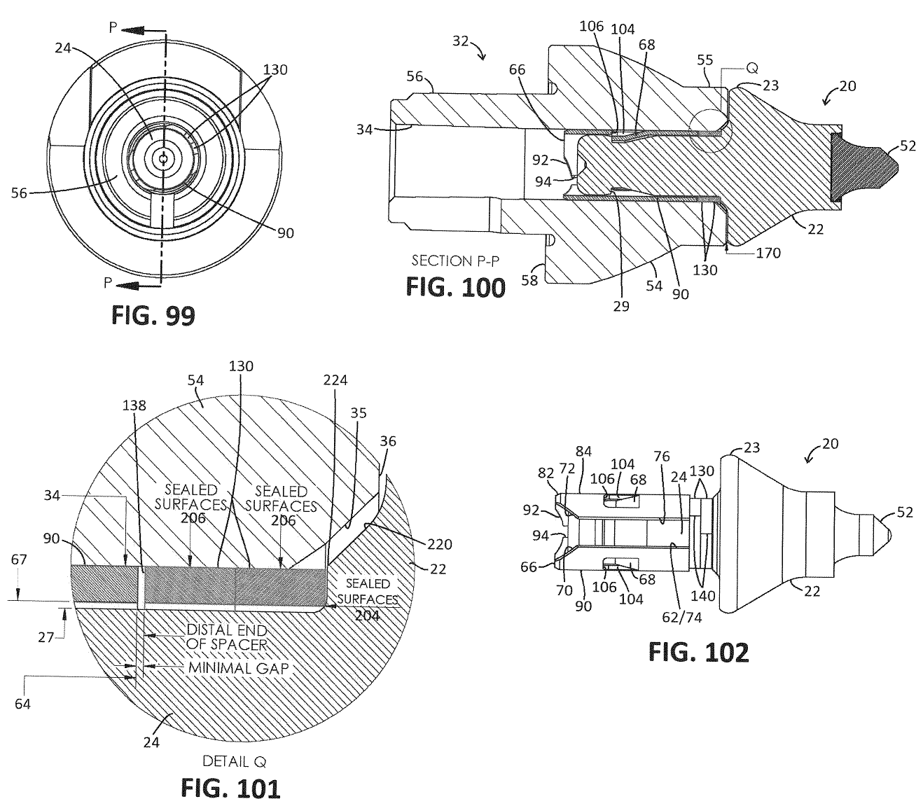

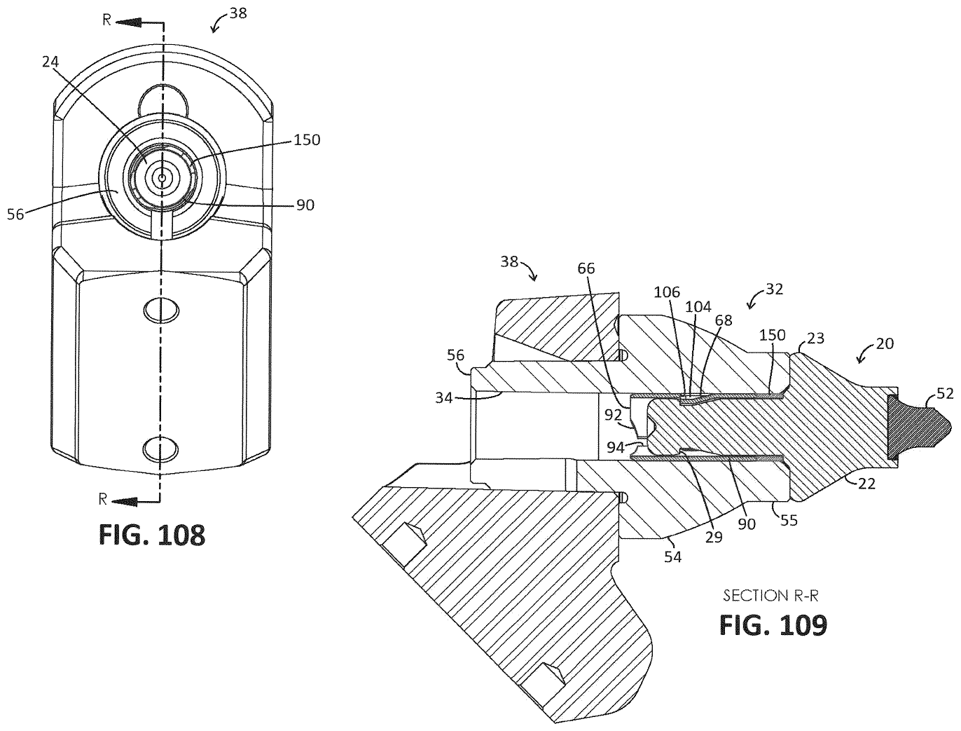

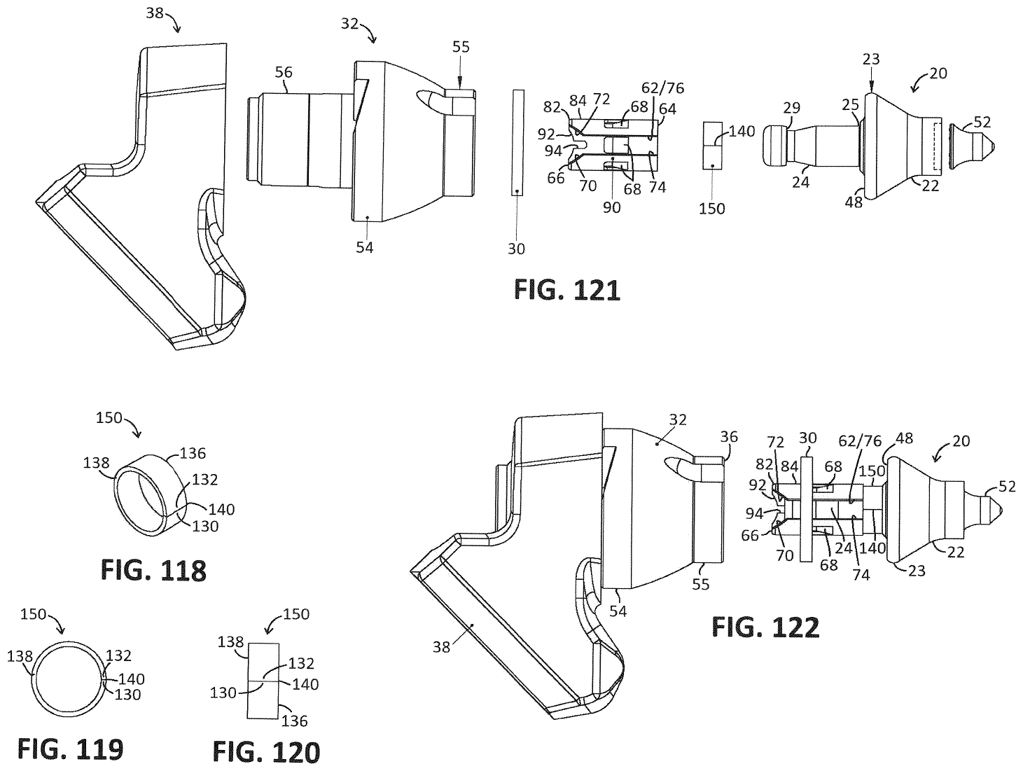

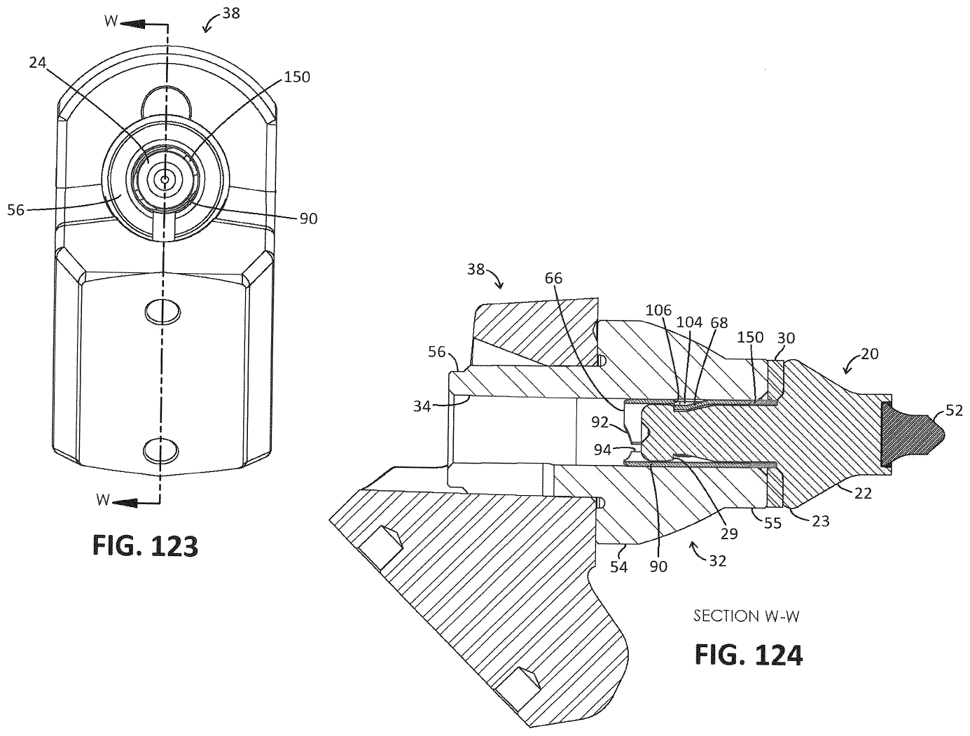

Referring to FIGS. 118-124, the retainer 60, 80, 90, 110, 120, 230 and the at least one spacer 150 may be used in conjunction with the washer 30 as described above with respect to FIGS. 101-105, 107-111, 113-120, and 122. Similarly, the retainer 60, 80, 90, 110, 120, 230 and the at least one spacer 130 may also be used in conjunction with the washer 30. In addition, the embodiments of the retainers 60, 80, 90, 110, 120, 230 and spacers 130, 150 can be used along with any other embodiments of a washer, such as those described in Applicant's co-pending U.S. Non-Provisional application Ser. No. 17/877,084, filed Jul. 29, 2022, in Applicant's issued U.S. Pat. No. 10,107,098, issued Oct. 23, 2018, and in Applicant's issued U.S. Pat. No. 10,612,376, issued Apr. 7, 2020, the contents of which are incorporated herein by reference in their entireties.

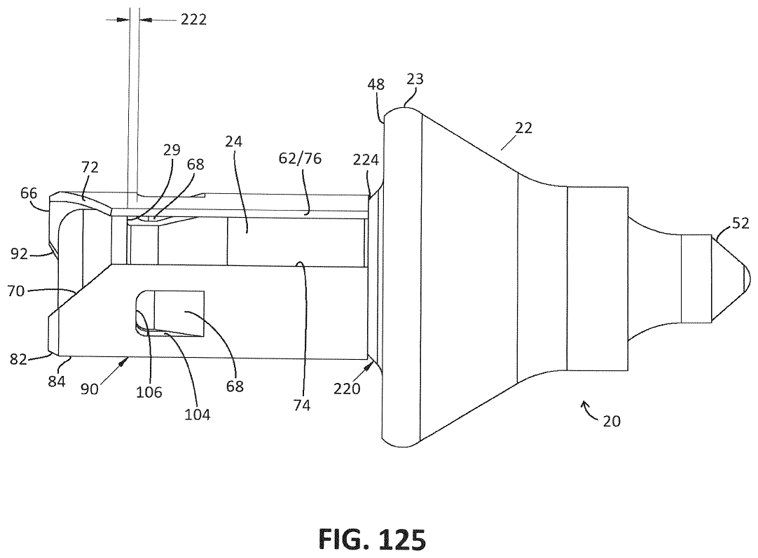

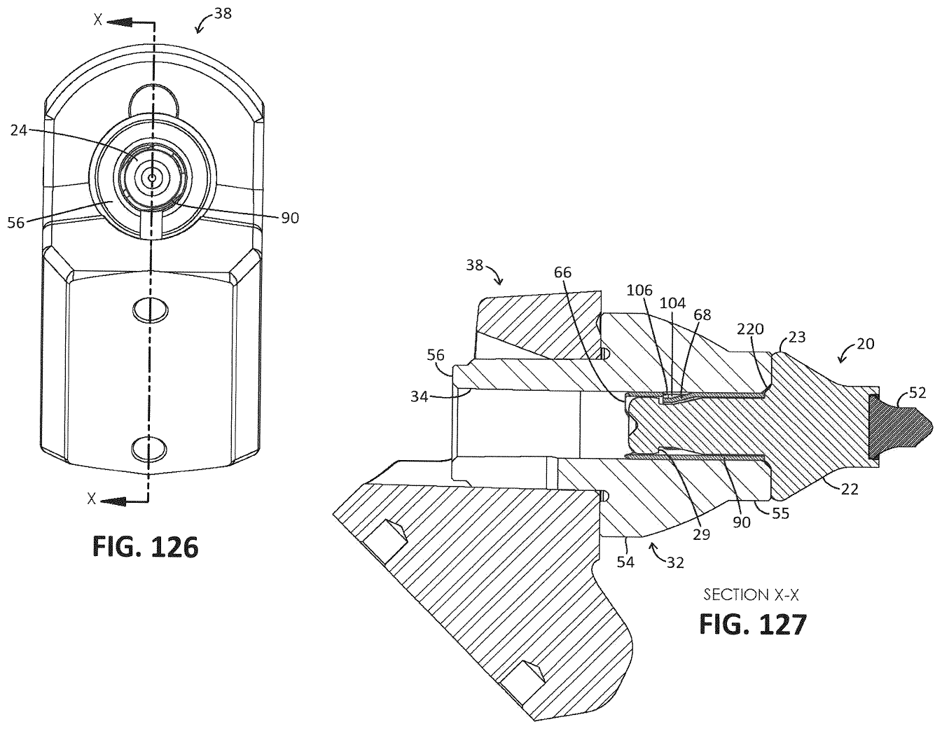

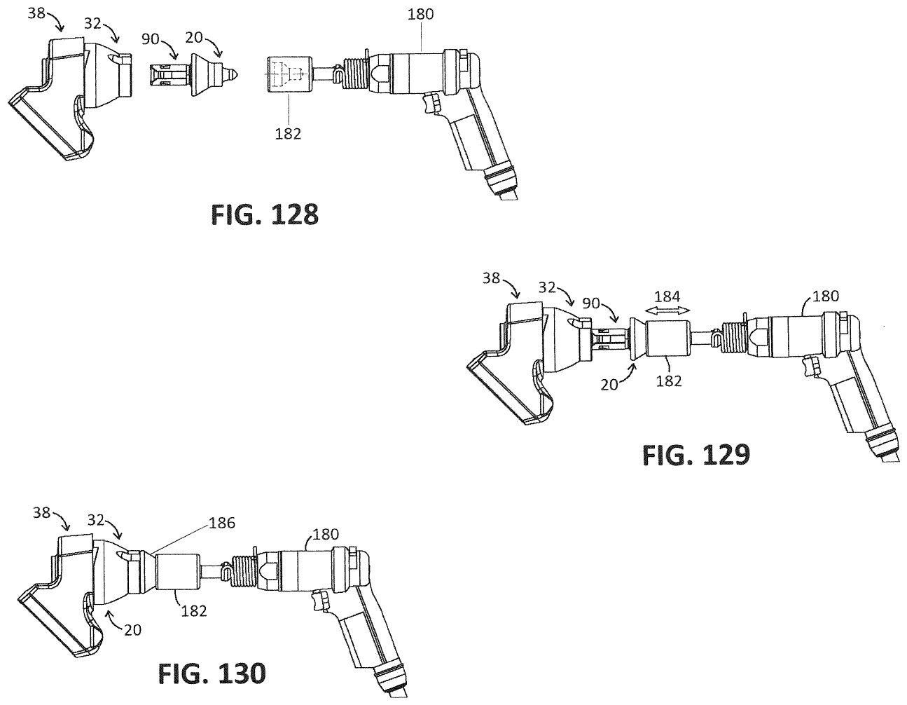

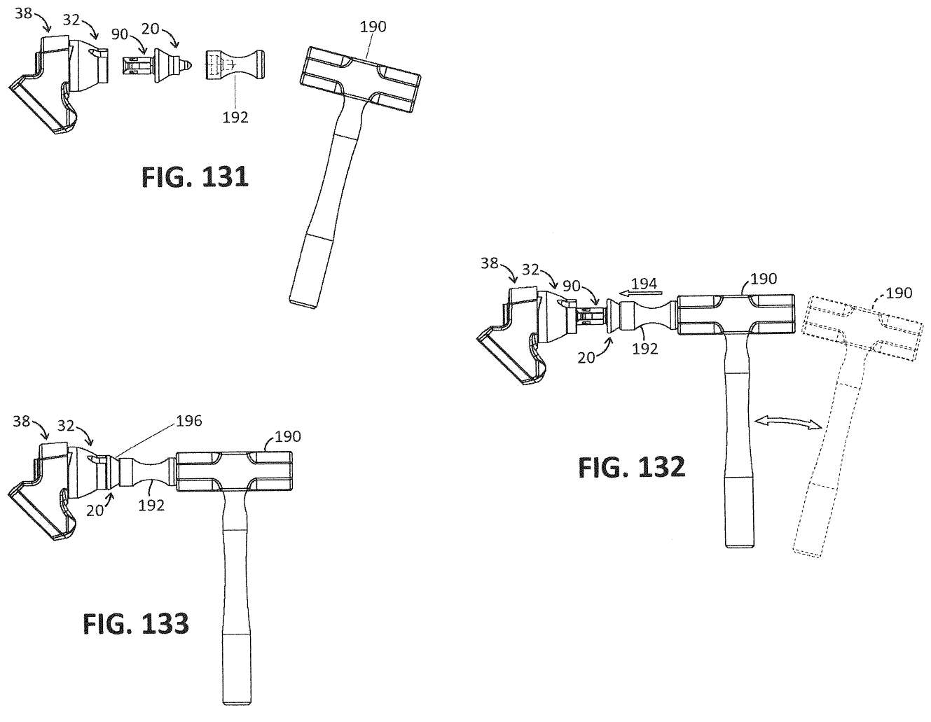

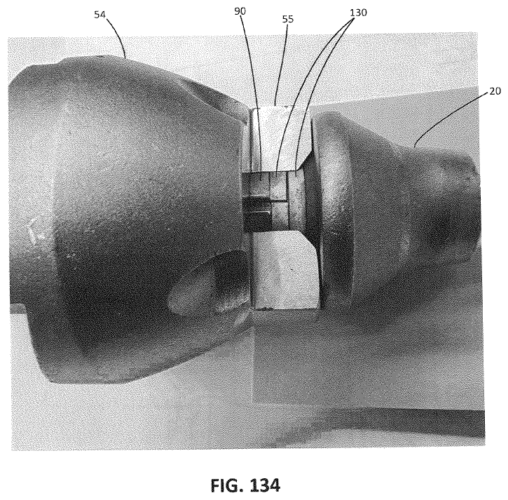

Referring to FIGS. 125-127, the retainer 60, 80, 90, 110, 120, 230 may also be used independently, without a spacer or a washer. The retainer 60, 80, 90, 110, 120, 230 is mounted circumferentially around the bit shank 24 of the bit 20 such that the forward end 64 of the retainer 60, 80, 90, 110, 120, 230 contacts and forms a significant seal with the distal end 224 of the angular portion 220 of the bit body 22 of the bit 20, the distal end 224 of the angular portion 220 adjacent the forward end 25 of the bit shank 24. In this exemplary illustrated implementation, the axial movement 222 of the bit shank 24 is less than the axial length of the angular portion 220 extending from the rear annular flange 48 of the bit body 22.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

1. A retainer comprising:
a generally cylindrical hollow body portion including an axial forward end and an axial distal end;
a first slot extending through a sidewall of the body portion from the axial forward end to the axial distal end;
a first angled portion extending from the axial distal end to a first radial end surface of the first slot; and
a second angled portion extending from the axial distal end to a second radial end surface of the first slot opposite the first radial end surface of the first slot.

2. The retainer of claim 1, the first angled portion and the second angled portion forming a dual corner break of the retainer adjacent the axial distal end of the retainer.

3. The retainer of claim 1, further comprising:
a chamfer at the axial distal end of the retainer extending to an outer surface of the retainer.

4. The retainer of claim 1, further comprising:
a notch opposite the axial forward end of the retainer, the notch extending inwardly from the axial distal end of the retainer.

5. The retainer of claim 4, further comprising:
a second slot axially extending from the notch through the sidewall of the retainer to a second slot termination, the second slot disposed approximately 180 degrees from the first slot.

6. The retainer of claim 1, the sidewall comprising at least one tab extending axially and radially inwardly, the at least one tab adapted to engage a flange on a shank of a bit to prevent the retainer from being removed from the shank.

7. The retainer of claim 4, wherein the notch is arcuate.

8. The retainer of claim 1, further comprising:
an angular notch extending from the axial distal end of the retainer approximately 180 degrees from the first slot of the retainer.

9. The retainer of claim 8, further comprising:
a first angled side of the angular notch extending from a first location at the axial distal end of the retainer to a vertex axially inward from the axial distal end of the retainer; and
a second angled side of the angular notch adjacent the first angled side, the second angled side extending from a second location at the axial distal end of the retainer to the vertex, the first location spaced from the second location at the axial distal end of the retainer.

10. A bit comprising:
a body portion;
a generally cylindrical shank axially depending from a bottom of the body portion; and
a retainer disposed circumferentially about the shank, the retainer comprising:
a generally cylindrical hollow retainer body portion including an axial forward end and an axial distal end;
a first slot extending through a sidewall of the retainer body portion from the axial forward end to the axial distal end;
a first angled portion extending from the axial distal end to a first radial end surface of the first slot; and
a second angled portion extending from the axial distal end to a second radial end surface of the first slot opposite the first radial end surface of the first slot.

11. The bit of claim 10, the first angled portion and the second angled portion forming a dual corner break of the retainer adjacent the axial distal end of the retainer.

12. The bit of claim 10, further comprising:
a chamfer at the axial distal end of the retainer extending to an outer surface of the retainer.

13. The bit of claim 10, further comprising:
a notch of the retainer opposite the axial forward end of the retainer, the notch extending inwardly from the axial distal end of the retainer.

14. The bit of claim 13, further comprising:
a second slot of the retainer axially extending from the notch through the sidewall of the retainer to a second slot termination, the second slot disposed approximately 180 degrees from the first slot.

15. The bit of claim 10, the sidewall of the retainer comprising at least one tab extending axially and radially inwardly, the at least one tab adapted to engage a flange on the shank of the bit to prevent the retainer from being removed from the shank.

16. The bit of claim 13, wherein the notch is arcuate.

17. The bit of claim 10, further comprising:
an angular notch of the retainer opposite the first slot, the angular notch extending axially inwardly from the axial distal end of the retainer to a vertex adjacent the axial distal end of the retainer.

18. The bit of claim 17, further comprising:
a first angled side of the angular notch extending from a first location at the axial distal end of the retainer to the vertex; and
a second angled side of the angular notch extending from a second location at the axial distal end of the retainer to the vertex, the first location spaced from the second location at the axial distal end of the retainer.

19. The bit of claim 10, further comprising:
at least one spacer disposed circumferentially about the shank between the bottom of the body portion and the axial forward end of the retainer.

20. The bit of claim 19, the at least one spacer comprising one of a nearly butted annular hollow spacer and a solid annular hollow spacer.

21. The bit of claim 19, a distal end of the at least one spacer contacting the axial forward end of the retainer.

22. The bit of claim 20, further comprising:
a first spacer radial end surface of the nearly butted annular hollow spacer;
a second spacer radial end surface of the nearly butted annular hollow spacer opposite the first spacer radial end surface, the first spacer radial end surface spaced from the second spacer radial end surface.

23. The retainer of claim 1, further comprising:
a gap profile defined by the first radial end surface and the second radial end surface of the first slot.

24. The retainer of claim 1, at least one of the first radial end surface and the second radial end surface of the first slot being at least one of linear, parallel, serpentine, arcuate, angular, and zig-zagged.

25. The retainer of claim 23, the gap profile of the first slot being at least one of linear, parallel, serpentine, arcuate, angular, and zig-zagged.

26. The bit of claim 10, the retainer further comprising:
a gap profile defined by the first radial end surface and the second radial end surface of the first slot.

27. The bit of claim 10, at least one of the first radial end surface and the second radial end surface of the first slot of the retainer being at least one of linear, parallel, serpentine, arcuate, angular, and zig-zagged.

28. The bit of claim 26, the gap profile of the first slot being at least one of linear, parallel, serpentine, arcuate, angular, and zig-zagged.

29. The bit of claim 10, further comprising:
a washer disposed circumferentially about the shank adjacent the bottom of the body portion.

30. The retainer of claim 4, the notch comprising a variable axial length.

31. The retainer of claim 5, the second slot comprising a variable axial length.

32. The retainer of claim 5, further comprising:
a second slot termination disposed a predetermined distance from the distal end of the retainer along an axial length of the retainer.

33. The retainer of claim 8, the angular notch comprising a variable axial length.

34. The retainer of claim 8, further comprising:
a second slot axially extending from the angular notch through the sidewall of the retainer to a second slot termination, the second slot disposed approximately 180 degrees from the first slot.

35. The retainer of claim 34, the second slot comprising a variable axial length.

36. The retainer of claim 34, further comprising:
a second slot termination of the second slot disposed a predetermined distance from the distal end of the retainer along an axial length of the retainer.

37. The bit of claim 13, the notch comprising a variable axial length.

38. The bit of claim 14, the second slot comprising a variable axial length.

39. The bit of claim 14, further comprising:
a second slot termination disposed a predetermined distance from the distal end of the retainer along an axial length of the retainer.

40. The bit of claim 17, the angular notch comprising a variable axial length.

41. The bit of claim 17, further comprising:
a second slot axially extending from the angular notch through the sidewall of the retainer to a second slot termination, the second slot disposed approximately 180 degrees from the first slot.

42. The bit of claim 41, the second slot comprising a variable axial length.

43. The bit of claim 41, further comprising:
a second slot termination of the second slot disposed a predetermined distance from the distal end of the retainer along an axial length of the retainer.
